(19) United States
(12) Patent Application Publication
(10) Pub. No.: US 2025/0086735 A1
(43) Pub. Date: Mar. 13, 2025

(54) MACHINE LEARNING FOR LEGAL CLAUSE EXTRACTION

(71) Applicant: Salesforce, Inc., San Francisco, CA (US)

(72) Inventors: Sundar Ram Vedula, Bangalore (IN); Rajdeep Dua, Hyderabad (IN); Akash Singh, Hyderabad (IN); Amit Kumar Dash, Bangalore (IN); Nimesh Gupta, Bangalore (IN); Sourav Sipani, Bangalore (IN); Ajay Singh, Bangalore (IN); Khyati Garg, Bangalore (IN); Sree Harini Soma, Bangalore (IN)

(21) Appl. No.: 18/427,275

(22) Filed: Jan. 30, 2024

(30) Foreign Application Priority Data
Sep. 11, 2023 (IN) 202341061034

(51) Int. Cl. G06Q 50/18

(52) U.S. Cl. CPC G06Q 50/18

(57) ABSTRACT

Methods, systems, apparatuses, devices, and computer program products are described. A system may support a machine learning model for legal clause extraction. The machine learning model may receive, as an input, at least a portion of a document and may output an indication of one or more legal clauses included in the document. To train the model, the system may receive a document and an indication of ground truths (e.g., legal clauses) for the document. The system may determine one-to-one mappings between the legal clauses indicated by the ground truths and the legal clauses indicated by the output of the machine learning model. The system may perform a longest common substring analysis on the one-to-one mappings to determine an accuracy of the machine learning model and may iteratively update the model based on the analysis.

### CROSS REFERENCE

The present Application for Patent claims the benefit of and priority to Indian Patent Application number 202341061034, by Vedula et al., entitled “MACHINE LEARNING FOR LEGAL CLAUSE EXTRACTION,” filed Sep. 11, 2023, assigned to the assignee hereof, and expressly incorporated by reference in its entirety herein.

### FIELD OF TECHNOLOGY

The present disclosure relates generally to database systems and data processing, and more specifically to machine learning for legal clause extraction.

### BACKGROUND

A cloud platform (i.e., a computing platform for cloud computing) may be employed by multiple users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

Some users, organizations, or both may create or otherwise use legal contracts (e.g., documents) to define legal obligations between parties. For example, a legal contract may include one or more legal clauses defining the rights for each party under the contract. However, due to the nuances of the language used in these contracts and the varying structures or formats of these contracts, identifying the legal clauses within a contract may be challenging for a machine learning model. Additionally, due to the lengths of text defining some contracts, a machine learning model may fail to accept the text of a contract as an input. In some cases, evaluating and fine-tuning such a machine learning model may involve significant compute resources and time, resulting in inefficiencies and inaccuracies in the model training.

### BRIEF DESCRIPTION OF THE DRAWINGS

FIG. 1 illustrates an example of a system for cloud computing that supports machine learning for legal clause extraction in accordance with aspects of the present disclosure.

FIG. 2 shows an example of a system that supports machine learning for legal clause extraction in accordance with aspects of the present disclosure.

FIG. 3 shows an example of a model training process that supports machine learning for legal clause extraction in accordance with aspects of the present disclosure.

FIG. 4 shows an example of a machine learning model that supports machine learning for legal clause extraction in accordance with aspects of the present disclosure.

FIG. 5 shows an example of a system that supports machine learning for legal clause extraction in accordance with aspects of the present disclosure.

FIG. 6 shows a block diagram of an apparatus that supports machine learning for legal clause extraction in accordance with aspects of the present disclosure.

FIG. 7 shows a block diagram of a legal clause extraction manager that supports machine learning for legal clause extraction in accordance with aspects of the present disclosure.

FIG. 8 shows a diagram of a system including a device that supports machine learning for legal clause extraction in accordance with aspects of the present disclosure.

FIGS. 9 through 11 show flowcharts illustrating methods that support machine learning for legal clause extraction in accordance with aspects of the present disclosure.

### DETAILED DESCRIPTION

A system (e.g., a multi-tenant database system or another system) may provide tools or services supporting management of legal contracts and legal language for individual users, organizations (e.g., tenants of the multi-tenant database system), or both. Some users, organizations, or both may create or otherwise use legal contracts (e.g., documents) to define legal obligations between parties. For example, a legal contract may include one or more legal clauses defining the rights for each party under the contract. A legal clause may define a set of goods, services, or both and how, when, and under what circumstances a party providing the goods, services, or both may be paid. In some cases, the legal clause may further define who owns the rights to the goods, services, or both, a length of a legal contract, one or more laws relevant to the contract, one or more consequences if there is a breach of the legal contract or a dispute over the legal contract, or any combination thereof. Due to the nuances of the language used in these legal contracts and the varying structures or formats of these contracts, identifying the legal clauses within a contract may be challenging for a machine learning model. Additionally, due to the lengths of some contract texts, a machine learning model may fail to accept the full text of a contract as an input. In some cases, evaluating and fine-tuning such a machine learning model may involve significant compute resources and time, resulting in inefficiencies and inaccuracies in the model training.

Techniques described herein may support accurate and efficient legal clause extraction from a document (e.g., a legal contract) using machine learning. For example, a system may support a machine learning model for legal clause extraction. The machine learning model may receive, as an input, at least a portion of a document and may output an indication of one or more legal clauses included in the document. In some examples, the machine learning model (or another machine learning model) may output an indication of one or more legal entities (e.g., individuals, organizations) mentioned in the document. To train the model, the system may receive a document and an indication of ground truths (e.g., legal clauses) for the document. The system may determine one-to-one mappings between the legal clauses indicated by the ground truths and the legal clauses indicated by the output of the machine learning model. The system may perform a longest common substring analysis on the one-to-one mappings to determine an accuracy of the machine learning model and may iteratively update the model based on the analysis. Using such techniques, the system may fine-tune the model to improve the accuracy of legal clause extraction.

In some examples, the system may implement chunking to handle relatively large documents (e.g., legal contracts). For example, the system may include a chunking module or process to determine portions of a document to input separately to the machine learning model. The system may determine the portions (e.g., text chunks) based on delimiters, image patterns, or both to avoid splitting a legal clause between multiple portions. For example, the system may determine the portions based on new line indications, full stops, sections headers, a white space search, or any combination thereof. In some cases, the chunking module may include a machine learning model trained to perform dynamic chunking of documents. Such techniques may improve the accuracy of the machine learning model by refraining from splitting a legal clause across separate portions, increasing the likelihood that the model can detect the full legal clause accurately.

Additionally, or alternatively, the system may implement String matching, edit distance, vector embeddings, unigram overlap, or any combination thereof to determine one-to-one mappings between the legal clauses indicated as ground truths and the legal clauses determined by the machine learning model. For example, the quantity of legal clauses indicated as ground truths may be different from the quantity of legal clauses output by the machine learning model. Other systems may fail to determine how to evaluate the accuracy of such a model, as there is no inherent one-to-one mapping supporting evaluation. The system may use the techniques described herein to automatically determine one-to-one mappings (e.g., including identifying false positives and false negatives in the machine learning output that are not included in the one-to-one mappings) to use for model evaluation. Additionally, other systems may evaluate accuracy based on summarization (e.g., a machine learning model output may be determined to be “close enough” or “semantically equivalent” if the model output is similar to, or a summary of, the corresponding ground truth). However, because exact language is important for legal definitions, the system may evaluate the machine learning model for perfect matches (e.g., in contrast to summaries or similar language). The system may use a longest common substring between a legal clause indicated as a ground truth and the corresponding legal clause output by the model to evaluate the accuracy of the machine learning model. Additionally, or alternatively, the system may freeze encoder weights, decoder weights, or both during model training to improve the efficiency of the model training, effectively reducing the compute resources and time involved in fine-tuning the machine learning model. Such techniques may improve the accuracy of the machine learning model for legal clause extraction while reducing the processing latency and overhead associated with the model training process.

Aspects of the disclosure are initially described in the context of systems for legal clause extraction. Additional aspects of the disclosure are described with reference to a machine learning model and a model training procedure. Aspects of the disclosure are further illustrated by and described with reference to apparatus diagrams, system diagrams, and flowcharts that relate to machine learning for legal clause extraction.

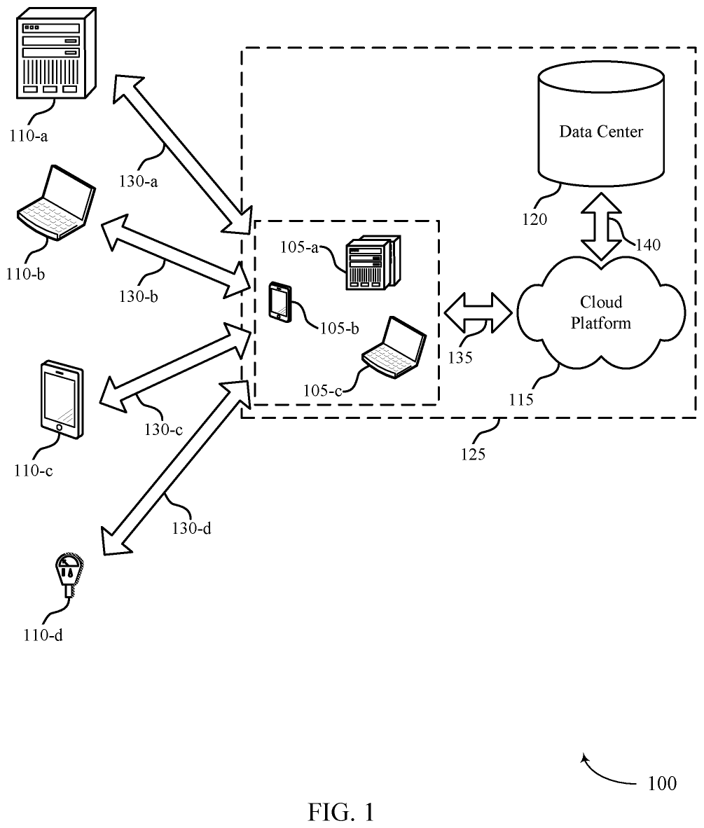

FIG. 1 illustrates an example of a system 100 for cloud computing that supports machine learning for legal clause extraction in accordance with aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135 and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

The system 100 may be an example of a multi-tenant system. For example, the system 100 may store data and provide applications, solutions, or any other functionality for multiple tenants concurrently. A tenant may be an example of a group of users (e.g., an organization) associated with a same tenant identifier (ID) who share access, privileges, or both for the system 100. The system 100 may effectively separate data and processes for a first tenant from data and processes for other tenants using a system architecture, logic, or both that support secure multi-tenancy. In some examples, the system 100 may include or be an example of a multi-tenant database system. A multi-tenant database system may store data for different tenants in a single database or a single set of databases. For example, the multi-tenant database system may store data for multiple tenants within a single table (e.g., in different rows) of a database. To support multi-tenant security, the multi-tenant database system may prohibit (e.g., restrict) a first tenant from accessing, viewing, or interacting in any way with data or rows associated with a different tenant. As such, tenant data for the first tenant may be isolated (e.g., logically isolated) from tenant data for a second tenant, and the tenant data for the first tenant may be invisible (or otherwise transparent, non-viewable) to the second tenant. The multi-tenant database system may additionally use encryption techniques to further protect tenant-specific data from unauthorized access (e.g., by users of another tenant).

Additionally, or alternatively, the multi-tenant system may support multi-tenancy for software applications and infrastructure. In some cases, the multi-tenant system may maintain a single instance of a software application and architecture supporting the software application in order to serve multiple different tenants (e.g., organizations, customers). For example, multiple tenants may share the same software application, the same underlying architecture, the same resources (e.g., compute resources, memory resources), the same database, the same servers or cloud-based resources, or any combination thereof. For example, the system 100 may run a single instance of software on a processing device (e.g., a server, server cluster, virtual machine) to serve multiple tenants. Such a multi-tenant system may provide for efficient integrations (e.g., using application programming interfaces (APIs)) by applying the integrations to the same software application and underlying architectures supporting multiple tenants. In some cases, processing resources, memory resources, or both may be shared by multiple tenants.

As described herein, the system 100 may support any configuration for providing multi-tenant functionality. For example, the system 100 may organize resources (e.g., processing resources, memory resources) to support tenant isolation (e.g., tenant-specific resources), tenant isolation within a shared resource (e.g., within a single instance of a resource), tenant-specific resources in a resource group, tenant-specific resource groups corresponding to a same subscription, tenant-specific subscriptions, or any combination thereof. The system 100 may support scaling of tenants within the multi-tenant system, for example, using scale triggers, automatic scaling procedures, scaling requests, or any combination thereof. In some cases, the system 100 may implement one or more scaling rules to enable relatively fair sharing of resources across tenants. For example, a tenant may have a threshold quantity of processing resources, memory resources, or both to use, which in some cases may be tied to a subscription by the tenant.

The system 100 (e.g., a multi-tenant database system or another system) may provide tools or services supporting management of legal contracts and legal language for individual users, organizations (e.g., tenants of the multi-tenant database system), or both. Some users, organizations, or both may create or otherwise use legal contracts (e.g., documents) to define legal obligations between parties. For example, a legal contract may include one or more legal clauses defining the rights for each party under the contract. A legal clause may define a set of goods, services, or both and how, when, and under what circumstances a party providing the goods, services, or both may be paid. In some cases, the legal clause may further define who owns the rights to the goods, services, or both, a length of a legal contract, one or more laws relevant to the contract, one or more consequences if there is a breach of the legal contract or a dispute over the legal contract, or any combination thereof. As compared to other text or sections in a document, a legal clause may carry a legal significance. For example, a legal clause may be an example of a specific point or provision in a law or legal document. A document may include no legal clauses, one or more legal clauses, other text or images unrelated to a legal clause, or any combination thereof.

Some other systems may use machine learning models to attempt to identify legal clauses within documents. In some cases, such systems may use prompt engineering with an out-of-the-box model (e.g., a large language model (LLM)) trained on internet data to identify the legal clauses. However, such a model may fail to accurately detect legal clauses based on the model not being trained on legal data, such that the model fails to understand complex legal clauses and terms. If such a model is instructed or otherwise programmed to extract legal clauses, the model may extract section headers as legal clauses. This may result in extracting legal clauses which are present as section headers and failing to extract legal clauses that are not present as section headers. Additionally, or alternatively, other systems may fail to handle documents satisfying a size threshold (e.g., exceeding a specific length). For example, the text of a document (e.g., a legal contract, which may range from a few pages to hundreds of pages) may fail to fit within the context window for a machine learning model. However, splitting the text of the document into smaller portions to fit within the context window may potentially split legal clauses across different portions, causing the machine learning model to fail to accurately detect these legal clauses.

Documents (e.g., legal contracts) may be of a variety of different formats and structures. For example, some documents may mention legal clauses explicitly as section headers, while some other documents may not explicitly mention legal clauses (e.g., legal clauses may be introduced in the middle of paragraphs, may span multiple sections). Machine learning models used by other systems may fail to handle such differences in formats and structures. Additionally, or alternatively, other systems may fail to accurately evaluate the outputs of a machine learning model. For example, the machine learning model may return one or more false positives, one or more false negatives, or both. Correspondingly, the quantity of legal clauses output by the model may be different from the quantity of actual legal clauses in a document. Because there is not a one-to-one mapping between the clauses output by the model and the actual clauses indicated for testing the model, the other systems may fail to perform automatic evaluation of the model. In some cases, even if the model correctly identifies the presence of a legal clause, the model may determine text for the legal clause that does not exactly match the actual text of the legal clause. For example, the output text may overlap, be a subset, or be a superset of the actual text for the legal clause. Other systems may fail to account for such differences when computing evaluation metrics for the model. Additionally, or alternatively, training a machine learning model may be relatively expensive in terms of compute resources and time.

In contrast, the system 100 may use techniques described herein to efficiently train an accurate machine learning model for legal clause extraction. In some examples, the machine learning model may be an example of an off-the-shelf pre-trained sequence-to-sequence LLM that the system 100 fine-tunes on legal contracts, such that the LLM learns legal language and terms in addition to the concept of legal clauses. The machine learning model may accurately extract legal clauses, entities (e.g., business entities, organizations, individuals), or both from a document (e.g., a legal contract). The system 100 may handle relatively large documents (e.g., contract documents spanning multiple pages that exceed a model context window length) using an intelligent chunking method to avoid splitting clauses across different text chunks. For example, the system 100 may use a configurable chunking module utilizing one or more heuristics or models to determine portions of a document to input separately into the machine learning model. The machine learning model may additionally handle different formats and structures of documents based on using legal data training sets. Additionally, or alternatively, the system 100 may perform automatic evaluation of extraction results by dynamically determining one-to-one mappings between model outputs and ground truths, detecting and removing false positives and false negatives from the mappings. The system 100 may use one or more custom metrics to facilitate automatic evaluation of legal clauses extracted by the machine learning model (e.g., testing for exact matches between the legal clause texts).

The system 100 may perform efficient fine-tuning of the machine learning model using a low-rank adaptation (LoRA) technique and freezing both encoder and decoder weights during iterative training to significantly reduce the compute overhead associated with the fine-tuning. LoRA may involve updating a relatively small quantity of weights (e.g., below a threshold quantity) during training. For example, the quantity of weights updated via LoRA may be significantly less (e.g., by an order of magnitude) than the full quantity of weights used by the machine learning model. Using such techniques (e.g., for intelligent contract extraction modeling), the system 100 may train and use a machine learning model that accurately extracts the legal clauses from a document with an improved processing overhead, processing latency, compute resources, or any combination thereof associated with training the machine learning model, running the machine learning model, or both.

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

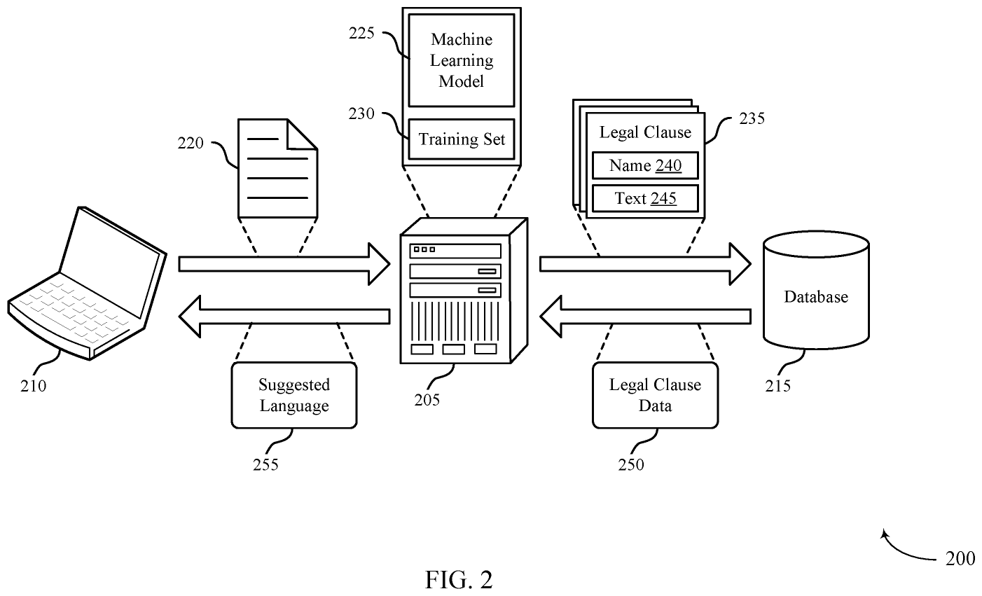

FIG. 2 shows an example of a system 200 that supports machine learning for legal clause extraction in accordance with aspects of the present disclosure. The system 200 may be an example of a system 100 as described with reference to FIG. 1. The system 200 may include a processing device 205, a user device 210, and a database 215, which may be examples of aspects of the system 100 as described with reference to FIG. 1. The processing device 205 may be an example of a server, a server cluster, an application server, a database server, a cloud-based server or service, a worker, a virtual machine, a container, a user device, or any combination of these or other computing devices. The user device 210 may be an example of a laptop, a smartphone, a desktop computer, a tablet, or any other device operated by a user. The database 215 may be an example or an aspect of a single database, a distributed database, multiple distributed databases, a data store, a data lake, an emergency backup database, a multi-tenant database system, or any combination of these or other data storage devices. The processing device 205 may support a machine learning model 225 that performs legal clause extraction on a document 220, such as a legal contract document.

The machine learning model 225 may be an example of an LLM (e.g., an artificial neural network), a classical machine learning model, or any other machine learning model. The system 200 may train the machine learning model 225 using legal data (e.g., in a training set 230). In some cases, one or more subject matter experts may contribute to the training set 230) (e.g., annotating documents to indicate the actual legal clauses included in the documents, forming a ground truth set). The system 200 may use the trained machine learning model 225 to perform automatic legal clause 235 extraction on one or more documents 220. For example, the processing device 205 may receive one or more documents 220) from a user device 210, from a database 215 (e.g., in a batch processing procedure), or from any other device or system. In some cases, the system 200 may retrain the machine learning model 225 based on a periodicity, a trigger (e.g., the machine learning model 225 failing to satisfy an accuracy threshold), or a user input. The machine learning model 225 training may be performed online, offline, or a combination thereof.

The processing device 205 may receive the document 220 and may input at least a portion of the document 220 into the machine learning model 225. For example, the processing device 205 may determine one or more inputs (e.g., an input vector, a text sequence) for the machine learning model 225 based on the document 220. If a size of the document 220 satisfies a threshold size (e.g., if the text of the document 220 fits within a context window size of the machine learning model 225), the processing device 205 may input text for the entire document 220 into the machine learning model 225. The context window of the machine learning model 225 may indicate a quantity of inputs or prompts, a quantity of output tokens, or both that the machine learning model 225 supports (e.g., in a single process). If the size of the document 220 fails to satisfy the threshold size (e.g., if the text of the document 220 exceeds the context window size of the machine learning model 225), the processing device 205 may segment the text of the document 220 into multiple portions and may input text for the different portions separately into the machine learning model 225. In this way, the machine learning model 225 may operate on different portions of the document 220 at different times—or in parallel—to determine legal clauses 235 included in the different portions of the document 220. In some examples, the processing device 205 may regroup the outputs of the machine learning model 225 for the different portions to send a complete set of legal clauses 235 identified for the document 220 to a database 215 for storage. For a legal clause 235, the machine learning model 225 may identify a respective name 240) and respective text 245 for the legal clause 235. The output of the machine learning model 225 may be a vector, a text sequence, a file (e.g., a JavaScript Object Notation (JSON) file), or any other format indicating the legal clauses 235 identified within (e.g., extracted from) the portion of the document 220 input into the machine learning model 225.

To determine the portions of the document 220 to use for the model inputs, the processing device 205 may perform a chunking procedure (e.g., using a chunking module). If the text of the document 220 exceeds the context window size (e.g., a size threshold) of the machine learning model 225, the processing device 205 may split the document 220 text into relatively smaller chunks (e.g., of sizes equal to or smaller than the context window size) and may run extraction for each text chunk independently. The processing device 205 (e.g., using the chunking module) may perform the chunking based on a chunk size threshold, a threshold quantity of tokens (e.g., individual characters of text, groups of characters of text, or other tokens) for the chunks (e.g., portions of the document 220), or both. For example, the processing device 205 may use a threshold chunk size C, satisfying P+C+O≤L, where P is a quantity of tokens in a prompt, O is a quantity of tokens in an output of the machine learning model 225, and L is the context window size (e.g., the context window limit). In some cases, in legal clause 235 extraction, the output size may be as large as the chunk size (e.g., if all of the text included in the chunk is part of one or more legal clauses 235). Accordingly, O=C is a boundary case, resulting in C≤(L−P)/2. In some examples, the processing device 205 may use a chunk size value relatively smaller than (L−P)/2 to allow for some buffer, b, such that C=(L−P)/2−b.

In some cases, using the same chunk size to determine multiple portions of a document may potentially result in suboptimal splits of the document text. For example, if the split point between chunks is in the middle of text associated with a specific legal clause, the legal clause may be split across different portions of the document and a machine learning model processing the portions separately may fail to identify the split legal clause or may identify partial text (e.g., not the entire text) corresponding to the legal clause.

To mitigate such suboptimal splits of the document text, the system 200 may use a flexible (e.g., configurable) chunking procedure. In some cases, the flexible chunking procedure may be an example of a “smart” chunking procedure that avoids relatively suboptimal splits of the document text between different chunks. The processing device 205 may dynamically determine points to split the document 220 into different chunks based on aspects of the document 220 text. In some examples, the processing device 205 may use delimiter-based chunking. For example, a section header included in the document 220 may be preceded by multiple new lines (e.g., new line characters, white space in an image). The processing device 205 (e.g., using the chunking module, which may include software components, hardware components, firmware components, or any combination thereof) may create (e.g., determine, generate) the portions of the document 220 based both on a threshold chunk size and multiple new lines identified within the document 220 (e.g., multiple sequential new lines or any other horizontal break in the text). For example, the processing device 205 may receive or determine the text of the document 220, a threshold chunk size C, a quantity of tokens to search (num_tokens_search), or any combination thereof. For the chunk size C, the processing device 205 may identify the token present in the document 220 at position C (e.g., corresponding to a threshold, or maximum, chunk size). If the identified token is a newline (e.g., a newline character), the processing device 205 may check whether the token is preceded or followed by one or more other newline characters. If the token at position C is preceded or followed by other newline characters, the processing device 205 may create a chunk from token 1 to token C. If not, the processing device 205 may search for multiple newline characters in sequence from token C to token C-num_tokens_search. If the processing device 205 identifies multiple newline characters in sequence, the processing device 205 may set the split point for the chunk at token K (e.g., a newline character with one or more newline characters preceding token K, following token K, or both), creating a chunk from token 1 to token K. If the processing device 205 fails to identify multiple newline characters in sequence from token C to token C-num_tokens_search, the processing device 205 may create a chunk of a default size (e.g., from token 1 to token C). In some cases, the processing device 205 may use additional, or alternative, delimiters for performing the flexible chunking of the document 220. For example, the processing device 205 may use multiple newlines, a single newline, a fullstop, a section header format, or any combination of these or other delimiters. In some examples, the processing device 205 may set different priorities for different delimiters and may perform the chunking based on the priorities.

Additionally, or alternatively, the processing device 205 may use image template search-based chunking. The processing device 205 may search for a relatively small image pattern within a relatively larger image to identify a point to perform the chunking. For example, if the document 220 is in an image format (e.g., a.jpg document or other image) and optical character recognition (OCR) on the document 220 fails or is relatively inaccurate, the processing device 205 may use the image template search. The processing device 205 may search for white space including multiple newlines as the pattern within the image. The processing device 205 may identify such patterns as potential splitting points for the document 220) (e.g., to create the different chunks). The processing device 205 may determine (e.g., select) one or more points to split the document 220 based on these identified image patterns and based on a threshold quantity of tokens (e.g., a quantity of tokens less than or equal to the threshold chunk size). Additionally, or alternatively, the processing device 205 may use an image feature-based classifier for performing the chunking. For example, the processing device 205 may use a machine learning classifier to identify section headers within the document 220 and may perform the chunking based on the section headers and the threshold chunk size.

The machine learning model 225 may receive the separate text chunks as inputs and may output one or more legal clauses 235 extracted from the separate text chunks. In some cases, the machine learning model 225 may send the legal clauses 235 to a database 215 for storage. In a multi-tenant database system, the database 215 may store the legal clauses 235 with associated tenant IDs (e.g., or otherwise in siloed tenant storage). For example, a first tenant may send the document 220 for legal clause 235 extraction based on the document 220 being an example of a legal contract signed or otherwise used by the first tenant. In some cases, the machine learning model 225 may support aspects of digitizing documents 220 (e.g., legal contracts) for one or more organizations (e.g., tenants), individuals, or both. The database 215 may store the legal clauses 235 extracted from the document 220 with one or more indications that the legal clauses 235 are associated with the first tenant (e.g., using a first tenant ID). Additionally, or alternatively, the database 215 may store an indication of the document 220 from which the legal clauses 235 were extracted (e.g., using a document ID). Accordingly, the database 215 (e.g., an example or component of a multi-tenant database system) may track legal clauses 235 that have been used by specific tenants.

In some examples, the system 200 may use such information to support legal clause suggestion, legal contract generation, or both for specific tenants. In some cases, the system 200 may receive a request from a user (e.g., a user operating a user device 210) to recommend one or more legal clauses 235 to include in a document, to generate a complete (or portions of a) document including one or more legal clauses 235, or both. In some other cases, the system 200 may automatically determine to recommend one or more legal clauses 235, generate a document including one or more legal clauses 235, or both, for example, based on user activity, communication analysis (e.g., performing natural language processing (NLP) on one or more emails or other messages), or any other information indicating that a user may be using a legal contract relatively soon. In some examples, the database 215 may send legal clause data 250 for processing at the processing device 205, and the processing device 205 may send suggested language 255 (e.g., one or more suggested legal clauses 235, including names 240), text 245, or both, one or more suggested legal documents) to a user device 210 for display via a user interface. In some cases, the processing device 205 may use one or more additional machine learning models 225 to determine the suggested language 255. If the user operating the user device 210—or another user—modifies the suggested language 255, the system 200 may feedback such modifications to further train the one or more machine learning models 225 determining the suggested language 255. In some systems (e.g., multi-tenant database systems), the processing device 205 may provide tenant-specific suggested language 255, for example, based on legal documents, legal clauses 235, or both previously used and approved by the different tenants.

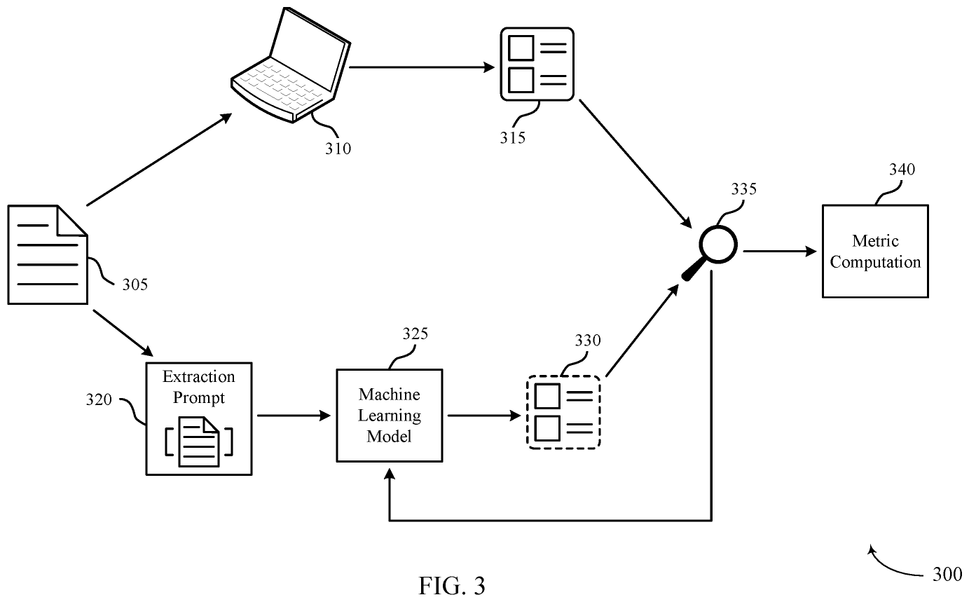

FIG. 3 shows an example of a model training process 300 that supports machine learning for legal clause extraction in accordance with aspects of the present disclosure. The model training process 300 may be performed by one or more aspects of a system 100 or a system 200 as described with reference to FIGS. 1 and 2. For example, one or more processing devices, such as a processing device 205 as described with reference to FIG. 2, may perform aspects of the model training process 300. Additionally, or alternatively, one or more user devices, such as a user device 210 as described with reference to FIG. 2, may perform aspects of the model training process 300. The model training process 300 may fine-tune a machine learning model 325 for legal clause extraction to improve the accuracy of the legal clauses output by the machine learning model 325.

The model training process 300 may involve training set construction. For example, a user (e.g., an expert user, such as a paralegal, lawyer, or other legal contract specialist) may annotate one or more documents 305 with legal clause data to indicate a set of ground truths 315. The one or more documents 305 used to generate the set of ground truths 315 may operate as a training set for fine-tuning the machine learning model 325 (e.g., an LLM or other model). A “ground truth” may be a legal clause identified by the expert user. Accordingly, the set of ground truths 315 for a document 305 (e.g., a legal contract document) may indicate the complete set of actual legal clauses included within the language of the document 305. The model training process 300 may use the set of ground truths 315 to analyze and improve the accuracy of the machine learning model 325.

In some examples, the training set may include one or more contract documents (e.g., documents 305) in the form of portable document format (PDF) files or image files (e.g., scanned documents). One or more subject matter experts (e.g., a user operating a user device 310) may review the training set and may indicate the legal clauses included in the documents 305 of the training set. For example, a subject matter expert may annotate the legal clauses present in a document 305 (e.g., bracketing the start and end of clauses, redlining the document 305 to indicate the legal clauses). In some cases, a processing device may generate a file indicating the set of ground truths 315 based on the annotations. For example, the processing device may include a machine learning model or other tool that receives an annotated document as input and outputs a JSON file including the set of ground truths 315. In some other cases, the subject matter expert or another user may create the file based on the identified legal clauses in the document 305. A processing device or database may store the file indicating the set of ground truths 315 to support the model training process 300.

An example file indicating the set of ground truths 315 may be formatted as a JSON array including a clause name, clause text, or both for each legal clause identified within the document 305 (e.g., forming the set of ground truths 315). For example, the following file, shown herein as an example for illustrative purposes, may indicate a “Date of Retirement” legal clause, a “Release Payment” legal clause, and an “Indemnification Right” legal clause included within a Release and Protective Agreement file:

```
[
  {
    “contract_file”: “release_and_protective_agreement.pdf”,
    “clauses”: [
      {
        “clause name”: “Date of Retirement”,
        “clause text”: “Executive's employment with the Company and all affiliated companies
ended effective as of February 28, 2020 (the “Retirement Date”). The end of Executive's
employment constituted a “separation from service” as defined in Section 409A of the
Internal Revenue Code of 1986, as amended, and the official guidance thereunder (“Section
409A”) as of the Retirement Date.”
      },
      {
        “clause name”: “Release Payment”,
        “clause text”: “In exchange for Executive's timely execution and non-revocation of this
Agreement, Executive shall receive $300,000, subject to all applicable tax withholdings (the
“Release Payment”). The Release Payment shall be paid in a single lump sum on the
Company's first regular payroll date which is on or immediately follows the thirtieth (30th)
day following the date this Agreement is executed (the “Effective Date”). Other than the
Release Payment and other benefits and payments specified in this Agreement, the Company
shall have no obligation to pay Executive any further compensation or remuneration,
including but not limited to base salary, commissions, bonuses, or reimbursement for
business expenses.”
      },
      {
        “clause name”: “Indemnification Right ”,
        “clause text”: “The Company shall indemnify Executive and hold him harmless for acts
or decisions made by him in good faith while performing services for the Company to the
extent provided by its organizational and governance documents and law, including any
rights to insurance benefits under any Directors & Officers liability insurance policy
maintained by the Company.”
      }
    ]
  }
]
```

In some cases, the JSON array may indicate the legal clauses for one or more documents 305, and each document 305 may include any quantity of legal clauses (e.g., no legal clauses, one legal clause, or multiple legal clauses).

The model training process 300 may additionally involve sending the training set of documents 305 for processing by the machine learning model 325. A processing device hosting—or otherwise supporting—the machine learning model 325 may determine a prompt 320 for the machine learning model 325 based on a received document 305 (e.g., a document 305 included in the training set). For example, the training set (X, Y) may include one or more pairs of prompts 320 and legal clauses (e.g., prompt-legal clause pairs), where the prompt 320 may be input to the machine learning model 325. In some cases, the prompt 320 may include multiple hierarchies, such as a system prompt and a task prompt. The system prompt may include instructions for guardrails for the machine learning model 325. For example, the system prompt may indicate a static prompt to implement one or more guardrails, such as guardrails for bias, toxicity, a prompt injection attack, or any other guardrails. The processing device may automatically refrain from training the machine learning model 325 based on a prompt 320 that fails to satisfy the indicated guardrails (e.g., a prompt 320 including some sort of bias). The task prompt may indicate a task-specific prompt to extract clauses and may indicate grounding data, such as a text chunk (e.g., at least a portion of the document 305 based on a chunking procedure or module), an output format (e.g., specifying an output format for downstream applications), or both. In some cases, a document 305 text chunk may be a dynamic part of the prompt 320. For example, the clause extraction prompt 320 may indicate:
Extract all the legal clauses present in the given contract document.
Format result as a JSON array of clauses. Each clause should have two keys:
   clause_name: Clause name inferred from the clause text.
   clause_text: Clause body or clause text extracted from the document.
Contract document: “‘document_chunk’”

The machine learning model 325 may process the prompt 320. For example, the processing device may generate one or more inputs (e.g., a sequence of text corresponding to at least a chunk of the document 305) to the machine learning model 325 based on the prompt 320. The machine learning model 325 may receive the inputs and may output (e.g., based on one or more layers, one or more weights, or any combination thereof) a determined set of legal clauses 330. Each legal clause may include a name of the legal clause and text indicating a legal significance of the legal clause. In some examples, the machine learning model 325 (or another machine learning model) may also output entities (e.g., names, email addresses, postal addresses, phone numbers, affiliations, business entities, organizations, tenants, individuals, or any other entities) identified from the inputs. For example, the machine learning model 325—or another similar machine learning model—may be trained to extract any entities (e.g., legal entities, including legal clauses or other information) from a document 305 (e.g., a legal document). The techniques described herein relating to legal clause extraction may additionally, or alternatively, be used for other types of entity extraction (e.g., to identify other important terms, objects, or items included in a legal document).

The model training process 300 may involve a comparison and analysis 335 between the set of ground truths 315 and the set of legal clauses 330 output by the machine learning model 325. The processing device may fine-tune the machine learning model 325 (e.g., an LLM) based on the comparison and analysis 335.

In some cases, to support the comparison and analysis 335, the processing device may dynamically determine a set of one-to-one mappings between the set of ground truths 315 and the set of legal clauses 330 output by the machine learning model 325. Some other evaluation metrics or services (e.g., NLP metrics), such as ROGUE or BLEU, may fail to evaluate the legal clause extraction results based on these metrics or services using a defined one-to-one correspondence between model outputs and ground truths. However, the set of ground truths 315 and the set of legal clauses 330 output by the machine learning model 325 may not inherently support a one-to-one mapping. For example, the prompt 320 may include a relatively large portion of document text including any quantity (e.g., not a pre-defined amount) of legal clauses. Additionally, or alternatively, the quantity of legal clauses in the set of legal clauses 330 output by the machine learning model 325 may be different from the quantity of legal clauses in the set of ground truths 315 (e.g., based on false negatives, false positives, or both). A “false negative” may be an example of a legal clause in the set of ground truths 315 that the machine learning model 325 failed to extract (e.g., does not correspond to any legal clause in the set of legal clauses 330). A “false positive” may be an example of a legal clause in the set of legal clauses 330 extracted by the machine learning model 325 that was not deemed to be a legal clause by a subject matter expert (e.g., does not correspond to any legal clause in the set of ground truths 315).

The processing device may perform clause alignment to dynamically determine one-to-one mappings between the set of ground truths 315 and the set of legal clauses 330. The processing device may identify one or more surplus legal clauses in the set of ground truths (e.g., false negatives), the set of legal clauses 330 (e.g., false positives), or both. Additionally, or alternatively, the processing device may determine if the same legal clause in one set corresponds to multiple legal clauses in the other set (e.g., with different names, different text, or both). In some cases, the processing device may use a hierarchical process (e.g., from relatively simple to relatively complex alignment techniques) to determine the one-to-one mappings.

In some examples, the hierarchical process may include five levels of alignment techniques. However, the processing device may use any quantity of levels and any order of levels to determine the one-to-one mappings. As an example, at a first level, the processing device may perform a String match on the clause names to determine mappings. For example, the processing device may use regex to match clause names between the set of ground truths 315 and the set of legal clauses 330. At a second level, the processing device may use edit distance to match clause names (e.g., relatively similar clause names between the set of ground truths 315 and the set of legal clauses 330). At a third level, the processing device may use vector embeddings of clause names to pair clauses. For example, the processing device may compute embeddings of clause names in a vector space and may determine mappings based on distances between the vector embeddings of a legal clause from the set of legal clauses 330 and a legal clause from the set of ground truths 315 satisfying (e.g., being less than) a threshold distance. At a fourth level, the processing device may use a unigram overlap between clause texts to determine mappings. For example, the processing device may compute a fraction of common unigrams between a legal clause from the set of legal clauses 330 and a legal clause from the set of ground truths 315 to match relatively similar clause texts. At a fifth level, the processing device may use vector embeddings of clause text to pair clauses. For example, the processing device may compute embeddings of clause texts in a vector space and may determine mappings based on distances between the vector embeddings of a legal clause from the set of legal clauses 330 and a legal clause from the set of ground truths 315 satisfying (e.g., being less than) a threshold distance. The processing device may achieve a one-to-one mapping of clauses in the set of ground truths 315 and the set of legal clauses 330 based on the clause alignment procedure. In some cases, the processing device may remove the clauses corresponding to false negatives and false positives from the comparison and analysis 335 to support the one-to-one mapping.

The comparison and analysis 335 may determine whether the paired legal clauses include the same name, the same text, or both. If a legal clause is extracted correctly (e.g., accurately) by the machine learning model 325, the corresponding legal clause in the pair (e.g., the ground truth) may have the same name and the same text. That is, the model training process 300 may train the machine learning model 325 to extract clause text verbatim, word-for-word from the document 305 (or at least a portion of the document 305). However, some legal clauses extracted by the machine learning model 325 may have a different name, different text, or both as compared to the corresponding legal clause in the pair (e.g., the ground truth). Some other evaluation metrics or services (e.g., NLP metrics), such as ROGUE or BLEU, may support summarization and machine translation tasks and may fail to support word-by-word matching analysis.

The comparison and analysis 335 may perform a word-by-word match analysis. In some examples, the comparison and analysis 335 may determine a word-by-word match score (e.g., using metric computation 340) for the pairings. For example, the processing device may evaluate a word-by-word match between the clause text of the paired legal clauses (e.g., a legal clause from the set of ground truths 315 and a paired legal clause from the set of legal clauses 330 extracted by the machine learning model 325). For a matching clause name, the processing device may retrieve the clause text present in the ground truth and the corresponding clause text in the model output. For the two clause texts, the processing device may compute a longest common substring (e.g., a longest common substring or a longest common subsequence). The processing device may compute the word-by-word match score for the clause text pair, for example, based on dividing the length of the longest common substring by the total quantity of words in the ground truth clause text. The processing device, for metric computation 340, may average the word-by-word match scores for a chunk of a document 305, the full document 305, or a full training set of documents 305 to determine a single metric for evaluation.

In some cases, the model training process 300 may fine-tune the machine learning model 325 (e.g., an LLM) based on an evaluation metric. In some examples, the evaluation metric may be dynamic, domain-specific, or both. For example, the model training process 300 may use different margins of error associated with the evaluation metric based on different use cases (e.g., using a relatively greater degree of tolerance if the process involves manual review of the results). For example, the processing device may trigger further training (e.g., fine-tuning) if the metric fails to satisfy a threshold accuracy. In some cases, the fine-tuning may be an iterative process. The model training process 300 may be performed online, offline, or a combination thereof. The model training process 300 may target improving word-for-word legal clause extraction (e.g., for names and text) from a document 305.

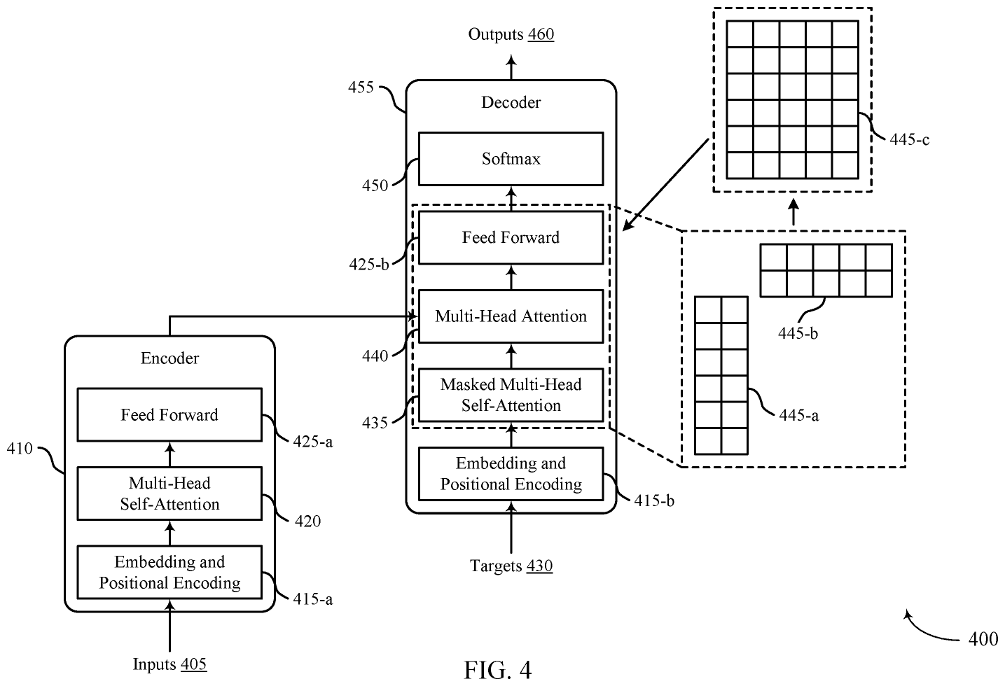

The fine-tuning process may involve constructing the prompt 320 based on an input contract sample (e.g., the document 305). For example, the processing device may construct the prompt 320 using one or more pre-defined or custom prompt templates. The processing device may pass the prompt 320 to the machine learning model 325 to generate the output clauses (e.g., the set of legal clauses 330). The processing device may compare the generated clauses with the ground truth labels and may compute a loss, for example, using a cross entropy loss function. The processing device may update weights (e.g., model weights or additional matrix weights, as described herein with reference to FIG. 4) based on the loss function. The processing device may iterate this process (e.g., iteratively computing loss values and updating weights) for each sample (e.g., each document 305 in a training set) using a supervised learning algorithm to train the machine learning model 325.

FIG. 4 shows an example of a machine learning model 400 that supports machine learning for legal clause extraction in accordance with aspects of the present disclosure. The machine learning model 400 may be an example of a machine learning model 225, a machine learning model 325, or both as described with reference to FIGS. 2 and 3. The machine learning model 400 may be an example of an LLM (e.g., an artificial neural network), a classical machine learning model, or any other machine learning model type. The machine learning model 400 may include one or more encoders 410, one or more decoders 455, or both. For example, the machine learning model 400 may include a transformer encoder-decoder architecture. However, in some other cases, the machine learning model 400 may use a different architecture. A device (e.g., a processing device or other system) may fine-tune the machine learning model 400 using a LoRA technique, freezing weights, or both. Such fine-tuning may improve the processing overhead and time associated with training the machine learning model 400.

The encoder 410 may receive one or more inputs 405 and may perform embedding and positional encoding 415-a using the inputs 405. The encoder 410 may additionally include a multi-head self-attention layer 420 and a feed forward layer 425-a for transforming the embeddings. In some examples, the encoder 410 may include multiple multi-head self-attention layers 420, multiple feed forward layers 425-a, or both. The decoder 455 may receive one or more targets 430, one or more embeddings from the encoder 410, or both. The decoder 455 may perform embedding and positional encoding 415-b using the targets 430. The decoder 455 may additionally include a masked multi-head self-attention layer 435, a multi-head attention layer 440, and a feed forward layer 425-b for transforming the embeddings (e.g., the embeddings based on the targets 430, the embeddings based on the inputs 405, or a combination thereof). In some examples, the decoder 455 may include multiple masked multi-head self-attention layers 435, multiple multi-head attention layers 440, multiple feed forward layers 425-b, or any combination thereof. The decoder 455 may additionally use a softmax function 450 to determine probabilities for the outputs 460. In some cases, the machine learning model 400 may include additional or alternative components to those described herein.

In some cases, the machine learning model 400 may be an example of an open-source LLM. An open-source LLM may be initially trained on a relatively large corpus of data publicly available on the internet. The vast majority of such data may fail to pertain to the legal domain and specifically to legal contracts (e.g., with legal clauses). As such, the open-source LLM may fail to understand legal language and the specifics of legal contracts, including the notions of clauses, obligations, parties, entities, or any combination thereof.

The device (e.g., processing device or system) may fine-tune the machine learning model 400 (e.g., a pre-trained open-source LLM) using legal clause-specific datasets. The transformer encoder-decoder architecture of the machine learning model 400 may support sequence-to-sequence tasks, where legal clause extraction may correspond to a sequence-to-sequence task. In some examples, the machine learning model 400 may receive, as an input 405, the original clause text and may send, as an output 460, a formatted version of the clauses (e.g., in a JSON format). In some other examples, the machine learning model 400 may receive, as an input 405, at least a portion of document text and may send, as an output 460, the legal clauses (e.g., names and text in a JSON format) extracted from the portion of the document text. The encoder 410 may develop an understanding of the input 405 (e.g., an input sequence), and the decoder 455 may generate the output 460) (e.g., an output sequence).

The device may perform a custom fine-tuning procedure to reduce the overhead associated with training the machine learning model 400 (e.g., the encoder 410, the decoder 455, or both). In some examples, the device may perform quantization. For example, the device may quantize the model weights, other scalars generated during training or inference (e.g., activations, gradients), or both to a 16-bit floating point format, bfloat16. Such quantization may reduce the memory footprint for model training (e.g., by 50% or some other percentage) and may improve the speed of performing calculations for the fine-tuning.

Additionally, or alternatively, the device may freeze model weights during the fine-tuning process. For example, the device may freeze the encoder weights during fine-tuning. The encoder 410 may be trained to generate one or more embeddings of the input text (e.g., the input 405). Such embeddings may be an intermediate representation of the input text and may be passed from the encoder 410 to the decoder 455. The decoder 455 may use the intermediate representation to generate task-specific output. Accordingly, the device may train the machine learning model 400 without modifying the encoder weights (e.g., training the decoder based on the embeddings, rather than training the entire encoder-decoder system based on the input 405). Freezing the weights may involve the device refraining from modifying the weights during the fine-tuning process (e.g., during an iterative update of one or more matrices).

Additionally, or alternatively, the device may freeze decoder weights during fine-tuning. The device may perform a parameter-efficient fine-tuning of the decoder 455 based on LoRA. The device may refrain from fine-tuning the full decoder weights during an iterative update process for training the machine learning model 400.

LoRA may be a fine-tuning technique in which the model weights are frozen and instead a pair of relatively low-rank decomposition matrices (e.g., a first matrix 445-a and a second matrix 445-b) are used for the layers (e.g., attention layers and feed forward layers) of the machine learning model 400 (e.g., for the decoder 455 in LoRA fine-tuning of the decoder 455). The device may train the weights in these pairs of matrices (e.g., the matrix values) rather than the model weights. In some cases, the device may train a pair of matrices (e.g., an A matrix and a B matrix, such as the first matrix 445-a and the second matrix 445-b) for each trainable weight layer (e.g., each attention layer, each feed forward layer) of the decoder 455, the encoder 410, or both. In some cases, the device may train weights for pairs of weight matrices for the decoder 455, but not the encoder 410, to improve a processing overhead associated with fine-tuning the machine learning model 400, for example, based on the encoder 410 being configured to interpret input text and the decoder 455 being configured to generate outputs for specific downstream applications or domains. Based on the rank of these pairs of matrices, the quantity of weights to be fine-tuned may be significantly reduced as compared to the quantity of weights in the decoder 455, improving compute overhead and training time. The device may perform the fine-tuning to train the matrix weights (e.g., the weights in the first matrix 445-a and the weights in the second matrix 445-b) such that the machine learning model 400 learns legal clause representations in a projected space represented by the matrices. By performing LoRA on the decoder 455 and not the encoder 410, the device may refrain from introducing matrices corresponding to the attention and feed forward layers of the encoder 410 (e.g., the multi-head self-attention layer 420 and the feed forward layer 425-a). Instead, the device may train weight matrices for the trainable layers of the decoder 455 and not for the trainable layers of the encoder 410, further improving the processing overhead and time associated with the fine-tuning process. In some cases, the device may iteratively train the weights of these matrices before updating the actual decoder weights using these matrices. For example, the device may keep the weight values frozen for current weight matrices of trainable layers of the decoder 455 during fine-tuning, instead updating the weight values (e.g., relatively fewer weight values) of the corresponding pairs of weight matrices.

To perform inference for the decoder 455, the device may multiply the first matrix 445-a and the second matrix 445-b to obtain a weight matrix 445-c. The weight matrix 445-c (e.g., an A×B matrix) may be equal in size (e.g., in both dimensions) to the corresponding decoder weight matrix (e.g., a current weight matrix for a trainable layer, such as a current weight matrix for a attention layer or a current weight matrix for a feed forward layer). In some examples, the device may select the ranks of the first matrix 445-a and the second matrix 445-b to support a weight matrix 445-c with dimensions equal to the decoder weight matrix. The device may add the weight matrix 445-c to the current decoder weight matrix (e.g., adding the matrix values to the previous decoder weights) to perform inference. The addition of the weight matrix 445-c to a trainable layer of the decoder 455 may apply the transformations to fine-tune the decoder 455 and output the correct legal clauses.

In some examples, the device may use a custom loss function to update the weights. For example, the machine learning model 400 may be pre-trained using cross entropy loss on various open datasets to learn distributions of tokens in a context free, domain-agnostic language. The custom loss function may support fine-tuning specific to the domain of legal contracts and legal clauses. For example, legal clauses may include specific words that occur at a relatively low frequency in the open datasets. The fine-tuning process may shift the language distribution of the machine learning model 400 from being domain-agnostic to applying specifically to the legal domain. The device may train the machine learning model 400 to identify (e.g., and weight) words which are important in legal clauses but occur relatively infrequently in a generic corpus.

Cross entropy loss may perform relatively poorly for minority classes in imbalanced datasets. Instead, the device may use weighted cross entropy loss to improve the fine-tuning process. The device may assign a set of class weights, with relatively higher weights assigned to classes that are important to the legal use case (e.g., for extracting legal clauses). The classes may be the words, tokens, or both present in the vocabulary of the model. A domain expert (e.g., a subject matter expert, such as a lawyer or paralegal) may identify words or terms important to legal clauses. The device may assign such words or terms relatively higher weights than other words or terms less important to legal clauses. In some cases, the device may assign weights greater than 1 to legal words or terms and may assign a weight of 1 to other words or terms. In some examples, the device may normalize the weights to sum to 1. In this way, the custom loss function may be a version of cross entropy loss where each token has a weight determined based on the original word's importance or frequency in a corpus of legal language. In some examples, the device may automatically determine the weights for different tokens based on comparing a relative frequency of a word in the corpus of legal language versus the relative frequency of the same word in a domain-agnostic corpus of language (e.g., domain-agnostic English text). For example, words like “force majeure” and “indemnification” may occur relatively more frequently in legal text as compared to general English text (e.g., domain-agnostic text).

In some systems, the machine learning model 400 may operate at a token level (e.g., character level, sets of characters level) rather than at a word level. In some such systems, the device may translate the word or term weights to the token level. For example, the word “indemnification” may be assigned a relatively higher weight based on being identified as relevant to legal clauses. However, some tokenization algorithms, such as Byte Pair Encoding, may separate the word “indemnification” into the tokens “ind,” “emn,” and “ification.” Some of these tokens may be present in other words that are not assigned a relatively higher weight. For example, the token “ification” may also be generated for the word “beautification,” which may not be relevant to legal clauses. To improve the weighting process, the device may transfer a word level weight to a token level weight if the token instance has originated from a word identified as important to the legal domain (e.g., a word assigned the relatively higher weight). For example, the phrase “indemnification beautification” may result in a token sequence of [“ind,” “emn,” “ification,” “beaut,” “ification”], with a corresponding weight array of [w, w, w, 1, 1], where the weight, w, is greater than 1. Accordingly, the two instances of “ification” are assigned different weights based on the different originating words.

In some examples, the device may use Equation 1 to calculate weighted cross entropy loss for a single extraction output.

$$- {\sum }_{i}^{n} {\sum }_{j}^{V} {ω}_{i j} * {y}_{i j} * log ( {p}_{i j} ) \qquad ( 1 )$$

In Equation 1, n is the quantity of tokens in the ground truth, V is the size of the token vocabulary, ωᵢⱼ is the weight assigned to the j^{th} token at position i, yᵢⱼ is the ground truth label for the i^{th} position and token j (where yᵢⱼ is 1 if the j^{th} token is the correct token at position i, and is otherwise 0), and pᵢⱼ is the probability assigned to the j^{th} token at position i. Equation 1 for the weighted cross entropy loss may alternatively be written using vectors. The device may update the weights of the matrices based on the calculated weighted cross entropy loss. In some cases, the device may append the stop token <s> to align ground truths with model outputs of different lengths.

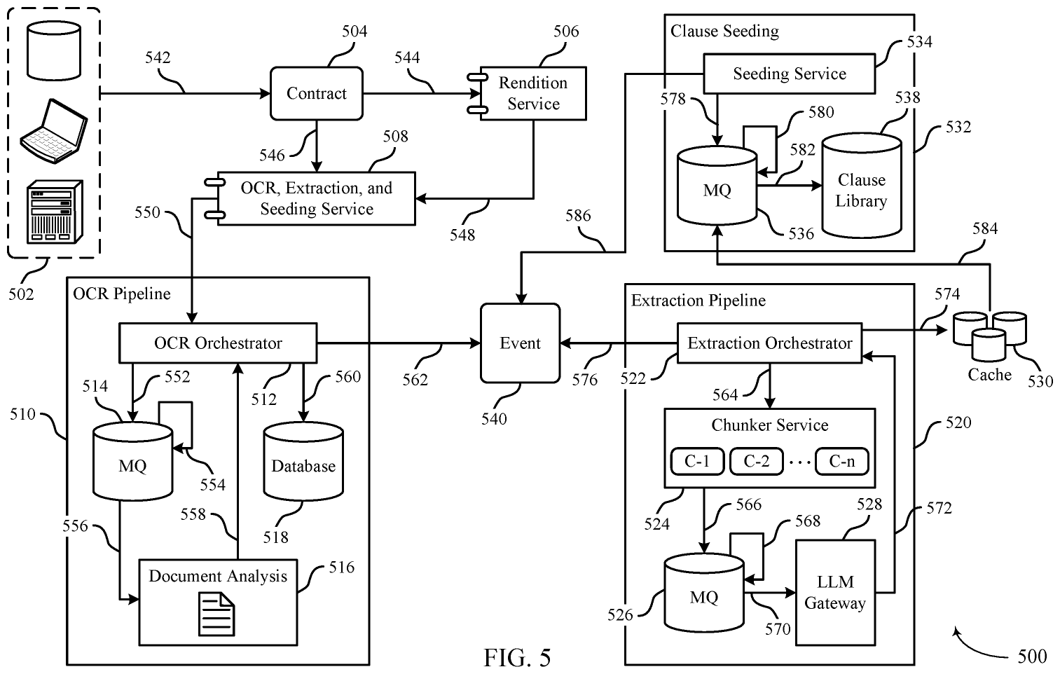

FIG. 5 shows an example of a system 500 that supports machine learning for legal clause extraction in accordance with aspects of the present disclosure. The system 500 may be an example of a system 100 or a system 200 as described herein with reference to FIGS. 1 and 2. The system 500 may be an example of a modeling workflow for legal clause extraction. The system 500 may include one or more pipelines (e.g., an OCR pipeline, an extraction pipeline), one or more contract sources, one or more services, one or more platform events, one or more data storage systems (e.g., caches, libraries, databases), one or more orchestrators, one or more services, one or more jobs, or any combination thereof. In some cases, the system 500 may be an example or a component of a multi-tenant database system.

At 542, a source device 502 may provide a legal contract 504 for analysis. The source device 502 may be an example of a user device (e.g., a user device 210 or a user device 310 as described with reference to FIGS. 2 and 3), a data source (e.g., a database or other data storage device, such as a data center 120 or a database 215 as described herein with reference to FIGS. 1 and 2), a processing device or system (e.g., a processing device 205 as described herein with reference to FIG. 2), a cloud client 105 or contact 110 as described herein with reference to FIG. 1, or any other device transmitting or otherwise sending a legal contract 504 for analysis. The legal contract 504 may be an example of a document in any document format. In some examples, at 544, the system 500 may send the legal contract 504 to a rendition service 506 to determine (e.g., generate, create) one or more renditions of the legal contract 504. A rendition may be an example of a file published in another format. For example, the legal contract 504 document may be an example of a PDF document, and the rendition service 506 may create a Microsoft Word version of the legal contract 504 document. An OCR, extraction, and seeding service 508 may receive the legal contract 504 at 546, a rendition of the legal contract 504 at 548, or both. The OCR, extraction, and seeding service 508 may support an OCR pipeline 510, an extraction pipeline 520, and a clause seeding pipeline 532 (e.g., a legal clause seeding service).

The OCR pipeline 510 may receive a document (e.g., the legal contract 504 or a rendition of the legal contract 504) at 550. At 552, an OCR orchestrator 512 may send the document to a message queue (MQ) 514 for processing. The MQ 514 may queue the document for OCR analysis. The MQ 514 may support asynchronous service-to-service communication, queueing documents (or portions of documents) for processing. In some cases, at 554, the MQ 514 may adjust the queue order based on one or more triggers (e.g., analysis priorities, user inputs). At 556, the MQ 514 may send a document (e.g., the next document in the queue) for document analysis 516. The document analysis 516 may perform OCR on the document to determine the text within the document. The document analysis 516 may send the resulting document with recognized text back to the OCR orchestrator 512 at 558. In some examples, at 560), the OCR orchestrator 512 may store the document with recognized text at a database 518 (e.g., a data center 120 or a database 215 as described herein with reference to FIGS. 1 and 2). Additionally, or alternatively, at 562, the OCR orchestrator 512 may trigger an event 540 (e.g., a platform event, such as an event integrated within a system, such as a CRM system) based on the document completing the OCR pipeline 510.

The extraction pipeline 520 may receive the document with recognized text (e.g., after completion of the OCR pipeline 510). For example, the extraction orchestrator 522 may receive the document and, at 564, may send the document to a chunker service 524. The chunker service 524 may determine whether a size of the document satisfies a context window threshold size for a machine learning model for legal clause extraction (e.g., an LLM). In some cases, the chunker service 524 may determine (e.g., partition, create) multiple chunks of text from the document text, where a respective size of each chunk of text satisfies (e.g., is less than) the context window threshold size. The chunker service 524 may perform dynamic, intelligent chunking (e.g., as described herein) to avoid splitting legal clauses across chunks. At 566, the chunker service 524 may send the text chunks to an MQ 526. In some cases, at 568, the MQ 526 may adjust the queue order based on one or more triggers (e.g., analysis priorities, user inputs). At 570, the MQ 526 may send a text chunk to an LLM gateway 528. For example, the LLM gateway 528 may support the context window threshold size and may receive inputs for the machine learning model for legal clause extraction. The machine learning model may extract any quantity of legal clauses from the received text chunk. For example, the machine learning model may identify zero, one, or more legal clauses within the received text chunk by analyzing the text, identifying legal words or tokens (e.g., corresponding to legal entities, legal terms), identifying delimiters (e.g., representing the beginnings and endings of legal clauses), or any combination thereof. At 572, the LLM gateway 528 may send the extracted legal clauses to the extraction orchestrator 522. At 574, the extraction orchestrator 522 may send the extracted legal clauses to a cache 530 for storage. Additionally, or alternatively, at 576, the extraction orchestrator 522 may trigger an event 540 (e.g., a platform event) based on completing legal clause extraction for a document (e.g., for each chunk of the document). For example, the system 500 may trigger the event 540 upon completion of the extraction pipeline 520 for a document with recognized text.

The clause seeding pipeline 532 may maintain a clause library 538 (e.g., a database of legal clauses determined by the extraction pipeline 520 or provided by one or more users, such as subject matter experts). A seeding service 534 may receive indications of one or more legal clauses (e.g., from a user or system). At 578, the seeding service 534 may send a legal clause to an MQ 536. Additionally, or alternatively, at 584, the cache 530 may send a legal clause (e.g., a legal clause extracted using the machine learning model) to the MQ 536. In some cases, at 580, the MQ 536 may adjust the queue order based on one or more triggers (e.g., analysis priorities, user inputs). At 582, the MQ 536 may send a legal clause to the clause library 538. In some cases, the clause library 538 may store tenant-agnostic legal clauses. Additionally, or alternatively, the clause library 538 may store tenant-specific legal clauses (e.g., in logically or physically siloed tenant storage). The system 500 may use the clause library 538 to suggest legal clauses for a tenant to include in a legal contract. In some examples, the system 500 may perform tenant-specific legal clause suggestion or legal contract generation using tenant-specific legal clause data securely stored at the clause library 538. At 586, the seeding service 534 may trigger an event 540 (e.g., a platform event) based on completing the clause seeding pipeline 532 (e.g., for a document).

In some examples, the event 540 may trigger one or more of the pipelines. For example, the event 540 may trigger the extraction pipeline 520 for a document based on completion of the OCR pipeline 510. Additionally, or alternatively, the event 540 may trigger the clause seeding pipeline 532 for a document based on completion of the extraction pipeline 520. In some cases, the event 540 may trigger other activities or actions supported by the system 500 (e.g., other database or CRM functions).

A processing device or system, such as a server, a server cluster, an application server, a database server, a cloud-based server or service, a worker, a virtual machine, a container, a user device, or any combination of these or other computing devices, may perform the functions described herein with reference to the OCR, extraction, and seeding service 508, the OCR pipeline 510, the extraction pipeline 520, the clause seeding pipeline 532, the event 540, or any combination thereof. In some cases, one or more of the OCR pipeline 510, the extraction pipeline 520, and the clause seeding pipeline 532 may run concurrently or asynchronously (e.g., as background operations, based on available processing resources).

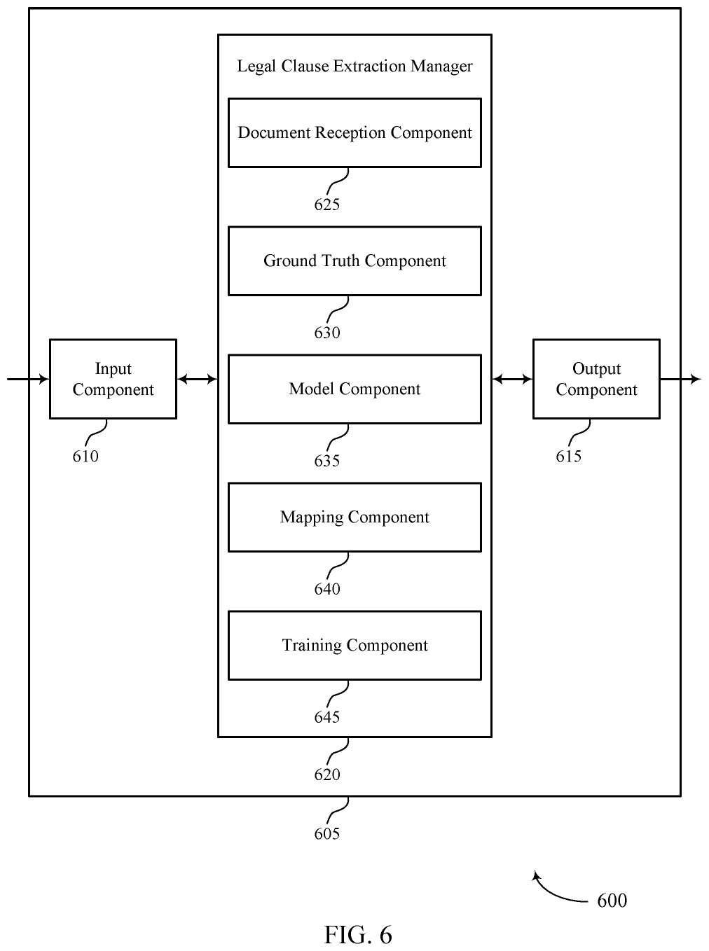

FIG. 6 shows a block diagram 600 of a device 605 that supports machine learning for legal clause extraction in accordance with aspects of the present disclosure. The device 605 may include an input component 610, an output component 615, and a legal clause extraction manager 620. The device 605, or one of more components of the device 605 (e.g., the input component 610, the output component 615, and the legal clause extraction manager 620), may include at least one processor, which may be coupled with at least one memory, to support the described techniques. Each of these components may be in communication with one another (e.g., via one or more buses).

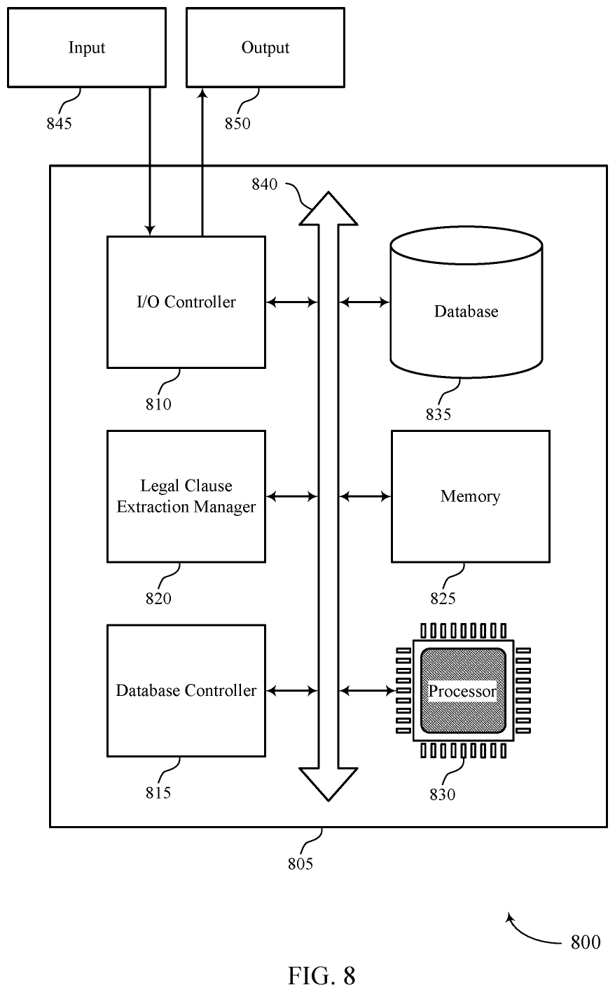

The input component 610 may manage input signals for the device 605. For example, the input component 610 may identify input signals based on an interaction with a modem, a keyboard, a mouse, a touchscreen, or a similar device. These input signals may be associated with user input or processing at other components or devices. In some cases, the input component 610 may utilize an operating system such as iOS®, ANDROID®, MS-DOS®, MS-WINDOWS®, OS/2®, UNIX®, LINUX®, or another known operating system to handle input signals. The input component 610 may send aspects of these input signals to other components of the device 605 for processing. For example, the input component 610 may transmit input signals to the legal clause extraction manager 620 to support machine learning for legal clause extraction. In some cases, the input component 610 may be a component of an input/output (I/O) controller 810 as described with reference to FIG. 8.

The output component 615 may manage output signals for the device 605. For example, the output component 615 may receive signals from other components of the device 605, such as the legal clause extraction manager 620, and may transmit these signals to other components or devices. In some examples, the output component 615 may transmit output signals for display in a user interface, for storage in a database or data store, for further processing at a server or server cluster, or for any other processes at any number of devices or systems. In some cases, the output component 615 may be a component of an I/O controller 810 as described with reference to FIG. 8.

For example, the legal clause extraction manager 620 may include a document reception component 625, a ground truth component 630, a model component 635, a mapping component 640, a training component 645, or any combination thereof. In some examples, the legal clause extraction manager 620, or various components thereof, may be configured to perform various operations (e.g., receiving, obtaining, monitoring, transmitting, sending) using or otherwise in cooperation with the input component 610, the output component 615, or both. For example, the legal clause extraction manager 620 may receive information from the input component 610, send information to the output component 615, or be integrated in combination with the input component 610, the output component 615, or both to receive information, transmit information, or perform various other operations as described herein.

The legal clause extraction manager 620 may support machine learning model training for legal clause extraction in accordance with examples as disclosed herein. The document reception component 625 may be configured to support receiving, from a first user device, a document. The ground truth component 630 may be configured to support receiving, from a second user device, an indication of a first set of legal clauses within the document, where a legal clause includes a name and text indicating a legal significance of the legal clause. The model component 635 may be configured to support inputting at least a portion of the document into a machine learning model, the machine learning model outputting a second set of legal clauses responsive to at least the portion of the document input into the machine learning model. The mapping component 640 may be configured to support determining a set of multiple one-to-one mappings between the first set of legal clauses and the second set of legal clauses based on a vector embedding procedure for the first set of legal clauses and the second set of legal clauses, where a mapping of the set of multiple one-to-one mappings includes a first legal clause from the first set of legal clauses and a second legal clause from the second set of legal clauses. The training component 645 may be configured to support updating the machine learning model based on an evaluation metric corresponding to the set of multiple one-to-one mappings, the evaluation metric based on a longest common substring between the first legal clause and the second legal clause of the mapping.

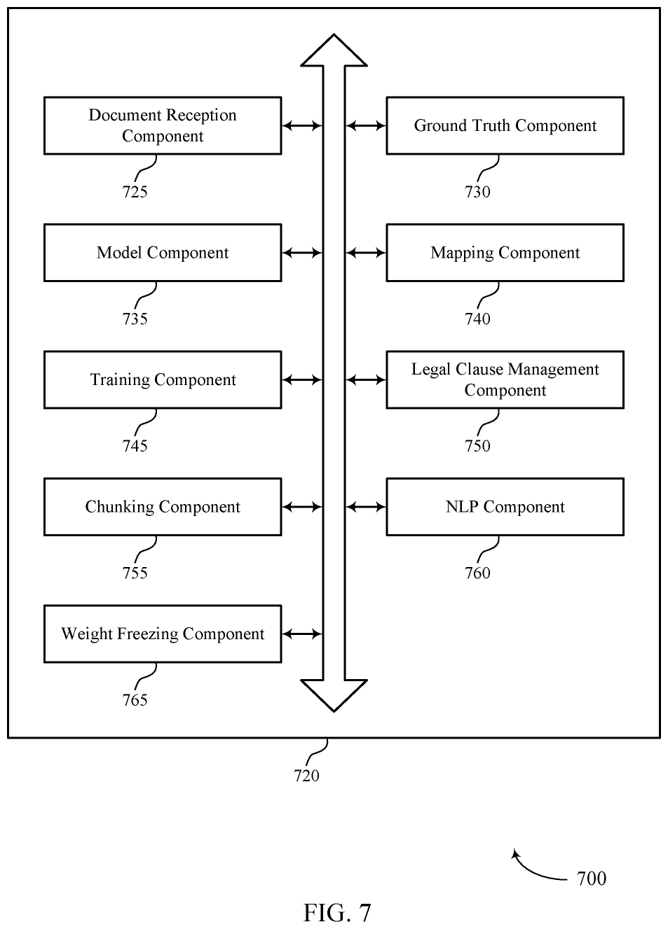

FIG. 7 shows a block diagram 700 of a legal clause extraction manager 720 that supports machine learning for legal clause extraction in accordance with aspects of the present disclosure. The legal clause extraction manager 720 may be an example of aspects of a legal clause extraction manager 620 as described herein. The legal clause extraction manager 720, or various components thereof, may be an example of means for performing various aspects of machine learning for legal clause extraction as described herein. For example, the legal clause extraction manager 720 may include a document reception component 725, a ground truth component 730, a model component 735, a mapping component 740, a training component 745, a legal clause management component 750, a chunking component 755, an NLP component 760, a weight freezing component 765, or any combination thereof. Each of these components, or components of subcomponents thereof (e.g., one or more processors, one or more memories), may communicate, directly or indirectly, with one another (e.g., via one or more buses).

The legal clause extraction manager 720) may support machine learning model training for legal clause extraction in accordance with examples as disclosed herein. The document reception component 725 may be configured to support receiving, from a first user device, a document. The ground truth component 730) may be configured to support receiving, from a second user device, an indication of a first set of legal clauses within the document, where a legal clause includes a name and text indicating a legal significance of the legal clause. The model component 735 may be configured to support inputting at least a portion of the document into a machine learning model, the machine learning model outputting a second set of legal clauses responsive to at least the portion of the document input into the machine learning model. The mapping component 740 may be configured to support determining a set of multiple one-to-one mappings between the first set of legal clauses and the second set of legal clauses based on a vector embedding procedure for the first set of legal clauses and the second set of legal clauses, where a mapping of the set of multiple one-to-one mappings includes a first legal clause from the first set of legal clauses and a second legal clause from the second set of legal clauses. The training component 745 may be configured to support updating the machine learning model based on an evaluation metric corresponding to the set of multiple one-to-one mappings, the evaluation metric based on a longest common substring between the first legal clause and the second legal clause of the mapping.

In some examples, the training component 745 may be configured to support transmitting, for display at a third user device, an indication of the evaluation metric, the first set of legal clauses, the second set of legal clauses, a set of multiple longest common substring results for the set of multiple one-to-one mappings, or any combination thereof.

In some examples, the legal clause management component 750 may be configured to support storing a set of multiple legal clauses output by the updated machine learning model. In some examples, the legal clause management component 750 may be configured to support generating a second document for a tenant of a multi-tenant database system based on one or more legal clauses of the stored set of multiple legal clauses associated with the tenant. In some examples, the legal clause management component 750 may be configured to support storing the second document for the tenant and generating one or more additional documents, one or more additional legal clauses, or both for the tenant based on the stored second document for the tenant and the one or more legal clauses of the stored plurality of legal clauses associated with the tenant. In some examples, the legal clause management component 750 may be configured to support transmitting, to a fourth user device associated with a tenant of a multi-tenant database system, a suggested legal clause based on the stored set of multiple legal clauses and a legal jurisdiction associated with the tenant, a geographic location associated with the tenant, a request associated with the tenant, or any combination thereof. In some examples, each legal clause of the set of multiple legal clauses is stored with an association to a tenant ID of a multi-tenant database system.

In some examples, the chunking component 755 may be configured to support determining a set of multiple portions of the document for inputting separately into the machine learning model based on a size of the document and a context window size of the machine learning model. In some examples, to support determining the set of multiple portions of the document, the chunking component 755 may be configured to support determining a start of a first portion of the document, an end of the first portion of the document, or both based on a new line in the document, a full stop in the document, a section header in the document, a white space search of the document, or any combination thereof.

In some examples, to support receiving the indication of the first set of legal clauses within the document, the ground truth component 730 may be configured to support receiving a JSON array including the first set of legal clauses. In some other examples, the ground truth component 730 may be configured to support generating a JSON array including the first set of legal clauses based on the indication of the first set of legal clauses within the document.

In some examples, to support updating the machine learning model, the training component 745 may be configured to support updating a first pair of weight matrices associated with an attention layer of the machine learning model, a second pair of weight matrices associated with a feed forward layer of the machine learning model, or both based on the evaluation metric. In some examples, the machine learning model includes one or more attention layers, one or more feed forward layers, or both. In some examples, to support updating the machine learning model, the training component 745 may be configured to support multiplying the first pair of weight matrices to determine a first weight matrix and multiplying the second pair of weight matrices to determine a second weight matrix, where a first size of the first weight matrix is equal to a second size of a first current weight matrix for the attention layer, and where a third size of the second weight matrix is equal to a fourth size of a second current weight matrix for the feed forward layer. In some examples, to support updating the machine learning model, the training component 745 may be configured to support applying the first weight matrix to the first current weight matrix for the attention layer and applying the second weight matrix to the second current weight matrix for the feed forward layer to determine the updated machine learning model. In some examples, to support updating the machine learning model, the training component 745 may be configured to support iteratively updating the first pair of weight matrices, the second pair of weight matrices, or both based on a set of multiple documents. In some examples, the weight freezing component 765 may be configured to support refraining from modifying the first current weight matrix for the attention layer and the second current weight matrix for the feed forward layer during the iterative updating.

In some examples, to support determining the set of multiple one-to-one mappings, the mapping component 740 may be configured to support determining the set of multiple one-to-one mappings further based on a String match analysis, an edit distance analysis, a unigram overlap analysis, or any combination thereof for the first set of legal clauses and the second set of legal clauses.

In some examples, to support determining the set of multiple one-to-one mappings, the mapping component 740 may be configured to support determining a false positive error for the machine learning model based on a third legal clause of the second set of legal clauses failing to map to a fourth legal clause of the first set of legal clauses based on the set of multiple one-to-one mappings, where updating the machine learning model is further based on the false positive error. In some examples, to support determining the set of multiple one-to-one mappings, the mapping component 740 may be configured to support determining a false negative error for the machine learning model based on a third legal clause of the first set of legal clauses failing to map to a fourth legal clause of the second set of legal clauses based on the set of multiple one-to-one mappings, where updating the machine learning model is further based on the false negative error.

In some examples, the training component 745 may be configured to support determining one or more tokens within a word of the document, assigning respective token weights to the one or more tokens based on the word and a corpus of legal language associated with a set of multiple legal clauses, and fine-tuning the machine learning model based on the respective token weights.

In some examples, the NLP component 760 may be configured to support determining, from the document, one or more individuals, one or more entities, or both based on an NLP analysis of the document.

FIG. 8 shows a diagram of a system 800 including a device 805 that supports machine learning for legal clause extraction in accordance with aspects of the present disclosure. The device 805 may be an example of or include the components of a device 605 as described herein. The device 805 may include components for bi-directional data communications including components for transmitting and receiving communications, such as a legal clause extraction manager 820, an I/O controller 810, a database controller 815, at least one memory 825, at least one processor 830, and a database 835. These components may be in electronic communication or otherwise coupled (e.g., operatively, communicatively, functionally, electronically, electrically) via one or more buses (e.g., a bus 840).

The I/O controller 810 may manage input signals 845 and output signals 850 for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. In other cases, the I/O controller 810 may represent or interact with a modem, a keyboard, a mouse, a touchscreen, or a similar device. In some cases, the I/O controller 810 may be implemented as part of a processor 830. In some examples, a user may interact with the device 805 via the I/O controller 810 or via hardware components controlled by the I/O controller 810.

The database controller 815 may manage data storage and processing in a database 835. In some cases, a user may interact with the database controller 815. In other cases, the database controller 815 may operate automatically without user interaction. The database 835 may be an example of a single database, a distributed database, multiple distributed databases, a data store, a data lake, or an emergency backup database.

Memory 825 may include random-access memory (RAM) and read-only memory (ROM). The memory 825 may store computer-readable, computer-executable software including instructions that, when executed, cause at least one processor 830 to perform various functions described herein. In some cases, the memory 825 may contain, among other things, a basic I/O system (BIOS) which may control basic hardware or software operation such as the interaction with peripheral components or devices. The memory 825 may be an example of a single memory or multiple memories. For example, the device 805 may include one or more memories 825.

The processor 830 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 830 may be configured to operate a memory array using a memory controller. In other cases, a memory controller may be integrated into the processor 830. The processor 830 may be configured to execute computer-readable instructions stored in at least one memory 825 to perform various functions (e.g., functions or tasks supporting machine learning for legal clause extraction). The processor 830 may be an example of a single processor or multiple processors. For example, the device 805 may include one or more processors 830.

The legal clause extraction manager 820 may support machine learning model training for legal clause extraction in accordance with examples as disclosed herein. For example, the legal clause extraction manager 820) may be configured to support receiving, from a first user device, a document. The legal clause extraction manager 820 may be configured to support receiving, from a second user device, an indication of a first set of legal clauses within the document, where a legal clause includes a name and text indicating a legal significance of the legal clause. The legal clause extraction manager 820 may be configured to support inputting at least a portion of the document into a machine learning model, the machine learning model outputting a second set of legal clauses responsive to at least the portion of the document input into the machine learning model. The legal clause extraction manager 820 may be configured to support determining a set of multiple one-to-one mappings between the first set of legal clauses and the second set of legal clauses based on a vector embedding procedure for the first set of legal clauses and the second set of legal clauses, where a mapping of the set of multiple one-to-one mappings includes a first legal clause from the first set of legal clauses and a second legal clause from the second set of legal clauses. The legal clause extraction manager 820 may be configured to support updating the machine learning model based on an evaluation metric corresponding to the set of multiple one-to-one mappings, the evaluation metric based on a longest common substring between the first legal clause and the second legal clause of the mapping.

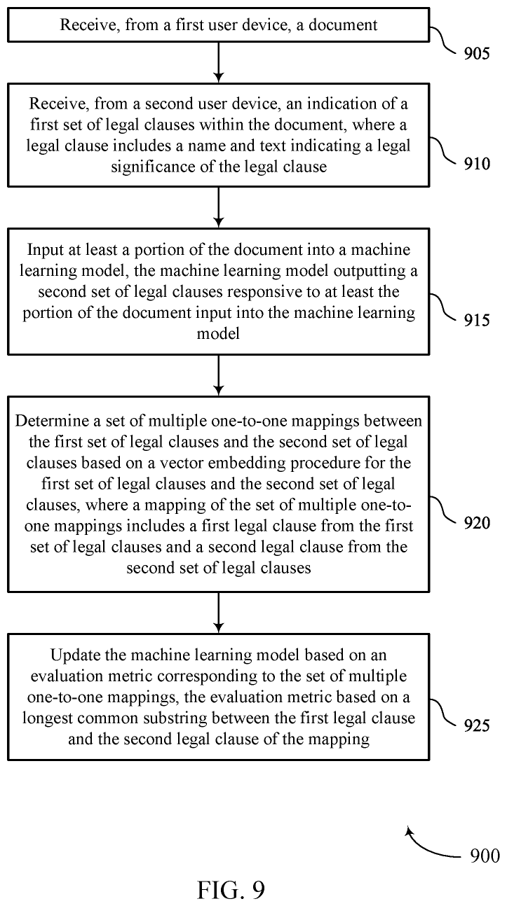

FIG. 9 shows a flowchart illustrating a method 900 that supports machine learning for legal clause extraction in accordance with aspects of the present disclosure. The operations of the method 900 may be implemented by a processing device (e.g., a server, a server cluster, an application server, a database server, a cloud-based server or service, a worker, a virtual machine, a container, a user device, or any combination of these or other computing devices) or its components as described herein. For example, the operations of the method 900 may be performed by a processing device as described with reference to FIGS. 1 through 8. In some examples, a processing device may execute a set of instructions to control the functional elements of the processing device to perform the described functions. Additionally, or alternatively, the processing device may perform aspects of the described functions using special-purpose hardware.

At 905, the method may include receiving, from a first user device, a document. The operations of block 905 may be performed in accordance with examples as disclosed herein. In some examples, aspects of the operations of 905 may be performed by a document reception component 725 as described with reference to FIG. 7.

At 910, the method may include receiving, from a second user device, an indication of a first set of legal clauses within the document, where a legal clause includes a name and text indicating a legal significance of the legal clause. The operations of block 910 may be performed in accordance with examples as disclosed herein. In some examples, aspects of the operations of 910 may be performed by a ground truth component 730 as described with reference to FIG. 7.

At 915, the method may include inputting at least a portion of the document into a machine learning model, the machine learning model outputting a second set of legal clauses responsive to at least the portion of the document input into the machine learning model. The operations of block 915 may be performed in accordance with examples as disclosed herein. In some examples, aspects of the operations of 915 may be performed by a model component 735 as described with reference to FIG. 7.

At 920, the method may include determining a set of multiple one-to-one mappings between the first set of legal clauses and the second set of legal clauses based on a vector embedding procedure for the first set of legal clauses and the second set of legal clauses, where a mapping of the set of multiple one-to-one mappings includes a first legal clause from the first set of legal clauses and a second legal clause from the second set of legal clauses. The operations of block 920 may be performed in accordance with examples as disclosed herein. In some examples, aspects of the operations of 920 may be performed by a mapping component 740 as described with reference to FIG. 7.

At 925, the method may include updating the machine learning model based on an evaluation metric corresponding to the set of multiple one-to-one mappings, the evaluation metric based on a longest common substring between the first legal clause and the second legal clause of the mapping. The operations of block 925 may be performed in accordance with examples as disclosed herein. In some examples, aspects of the operations of 925 may be performed by a training component 745 as described with reference to FIG. 7.

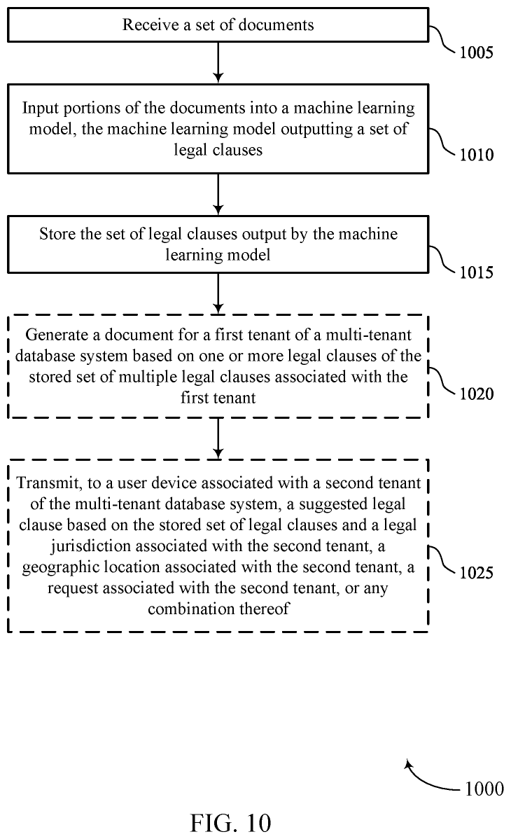

FIG. 10 shows a flowchart illustrating a method 1000 that supports machine learning for legal clause extraction in accordance with aspects of the present disclosure. The operations of the method 1000 may be implemented by a processing device (e.g., a server, a server cluster, an application server, a database server, a cloud-based server or service, a worker, a virtual machine, a container, a user device, or any combination of these or other computing devices) or its components as described herein. For example, the operations of the method 1000 may be performed by a processing device as described with reference to FIGS. 1 through 8. In some examples, a processing device may execute a set of instructions to control the functional elements of the processing device to perform the described functions. Additionally, or alternatively, the processing device may perform aspects of the described functions using special-purpose hardware.

At 1005, the method may include receiving a set of documents for legal clause extraction. The operations of block 1005 may be performed in accordance with examples as disclosed herein. In some examples, aspects of the operations of 1005 may be performed by a document reception component 725 as described with reference to FIG. 7.

At 1010, the method may include inputting portions of the documents into a machine learning model. The machine learning model may output a set of legal clauses responsive to at least the portions of the documents input into the machine learning model. The operations of block 1010 may be performed in accordance with examples as disclosed herein. In some examples, aspects of the operations of 1010 may be performed by a model component 735 as described with reference to FIG. 7.

At 1015, the method may include storing the set of legal clauses output by the machine learning model. The operations of block 1015 may be performed in accordance with examples as disclosed herein. In some examples, aspects of the operations of 1015 may be performed by a legal clause management component 750 as described with reference to FIG. 7.

In some examples, at 1020, the method may include generating a document for a first tenant of a multi-tenant database system based on one or more legal clauses of the stored set of legal clauses associated with the first tenant. The operations of block 1020 may be performed in accordance with examples as disclosed herein. In some examples, aspects of the operations of 1020 may be performed by a legal clause management component 750 as described with reference to FIG. 7.

In some examples, at 1025, the method may include transmitting, to a user device associated with a second tenant of the multi-tenant database system, a suggested legal clause based on the stored set of legal clauses and a legal jurisdiction associated with the second tenant, a geographic location associated with the second tenant, a request associated with the second tenant, or any combination thereof. The operations of block 1025 may be performed in accordance with examples as disclosed herein. In some examples, aspects of the operations of 1025 may be performed by a legal clause management component 750 as described with reference to FIG. 7.

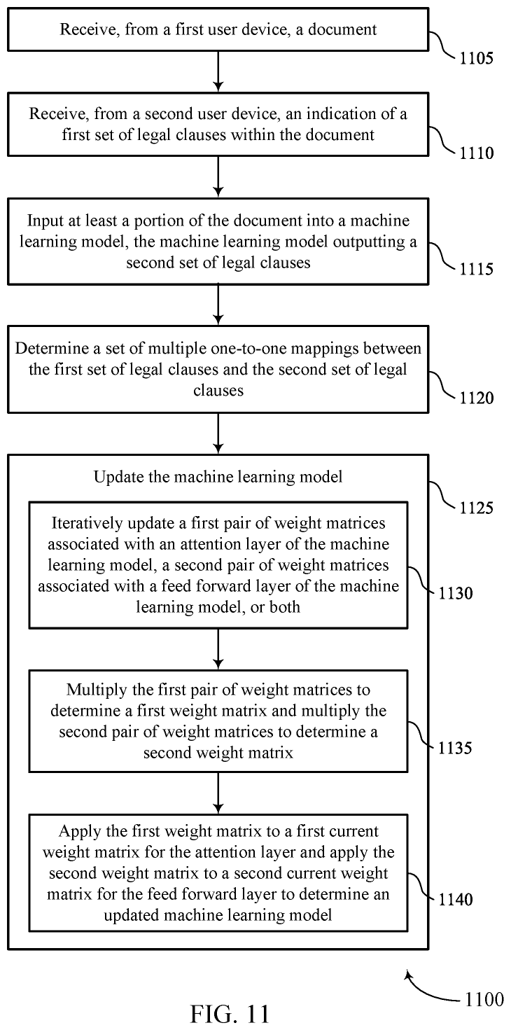

FIG. 11 shows a flowchart illustrating a method 1100 that supports machine learning for legal clause extraction in accordance with aspects of the present disclosure. The operations of the method 1100 may be implemented by a processing device (e.g., a server, a server cluster, an application server, a database server, a cloud-based server or service, a worker, a virtual machine, a container, a user device, or any combination of these or other computing devices) or its components as described herein. For example, the operations of the method 1100 may be performed by a processing device as described with reference to FIGS. 1 through 8. In some examples, a processing device may execute a set of instructions to control the functional elements of the processing device to perform the described functions. Additionally, or alternatively, the processing device may perform aspects of the described functions using special-purpose hardware.

At 1105, the method may include receiving, from a first user device, a document. The operations of block 1105 may be performed in accordance with examples as disclosed herein. In some examples, aspects of the operations of 1105 may be performed by a document reception component 725 as described with reference to FIG. 7.

At 1110, the method may include receiving, from a second user device, an indication of a first set of legal clauses within the document. A legal clause may include a name and text indicating a legal significance of the legal clause. The operations of block 1110 may be performed in accordance with examples as disclosed herein. In some examples, aspects of the operations of 1110 may be performed by a ground truth component 730 as described with reference to FIG. 7.

At 1115, the method may include inputting at least a portion of the document into a machine learning model. The machine learning model may output a second set of legal clauses responsive to at least the portion of the document input into the machine learning model. The operations of block 1115 may be performed in accordance with examples as disclosed herein. In some examples, aspects of the operations of 1115 may be performed by a model component 735 as described with reference to FIG. 7.

At 1120, the method may include determining a set of multiple one-to-one mappings between the first set of legal clauses and the second set of legal clauses (e.g., based on a vector embedding procedure for the first set of legal clauses and the second set of legal clauses). A mapping of the set of multiple one-to-one mappings includes a first legal clause from the first set of legal clauses and a second legal clause from the second set of legal clauses. The operations of block 1120 may be performed in accordance with examples as disclosed herein. In some examples, aspects of the operations of 1120 may be performed by a mapping component 740 as described with reference to FIG. 7.

At 1125, the method may include updating the machine learning model based on the set of multiple one-to-one mappings. The operations of block 1125 may be performed in accordance with examples as disclosed herein. In some examples, aspects of the operations of 1125 may be performed by a training component 745 as described with reference to FIG. 7.

At 1130, the method may include iteratively updating a first pair of weight matrices associated with an attention layer of the machine learning model, a second pair of weight matrices associated with a feed forward layer of the machine learning model, or both based on a set of multiple documents. The operations of block 1130 may be performed in accordance with examples as disclosed herein. In some examples, aspects of the operations of 1130 may be performed by a training component 745 as described with reference to FIG. 7.

At 1135, the method may include multiplying the first pair of weight matrices to determine a first weight matrix and multiplying the second pair of weight matrices to determine a second weight matrix. A first size of the first weight matrix may be equal to a second size of a first current weight matrix for the attention layer, and a third size of the second weight matrix may be equal to a fourth size of a second current weight matrix for the feed forward layer. The operations of block 1135 may be performed in accordance with examples as disclosed herein. In some examples, aspects of the operations of 1135 may be performed by a training component 745 as described with reference to FIG. 7.

At 1140, the method may include applying the first weight matrix to the first current weight matrix for the attention layer and applying the second weight matrix to the second current weight matrix for the feed forward layer to determine an updated machine learning model. The operations of block 1140 may be performed in accordance with examples as disclosed herein. In some examples, aspects of the operations of 1140 may be performed by a training component 745 as described with reference to FIG. 7.

A method for machine learning model training for legal clause extraction is described. The method may include receiving, from a first user device, a document, receiving, from a second user device, an indication of a first set of legal clauses within the document, where a legal clause includes a name and text indicating a legal significance of the legal clause, inputting at least a portion of the document into a machine learning model, the machine learning model outputting a second set of legal clauses responsive to at least the portion of the document input into the machine learning model, determining a set of multiple one-to-one mappings between the first set of legal clauses and the second set of legal clauses based on a vector embedding procedure for the first set of legal clauses and the second set of legal clauses, where a mapping of the set of multiple one-to-one mappings includes a first legal clause from the first set of legal clauses and a second legal clause from the second set of legal clauses, and updating the machine learning model based on an evaluation metric corresponding to the set of multiple one-to-one mappings, the evaluation metric based on a longest common substring between the first legal clause and the second legal clause of the mapping.

An apparatus for machine learning model training for legal clause extraction is described. The apparatus may include one or more memories storing processor executable code and one or more processors coupled with the one or more memories. The one or more processors may be individually or collectively operable to execute the code to cause the apparatus to receive, from a first user device, a document, receive, from a second user device, an indication of a first set of legal clauses within the document, where a legal clause includes a name and text indicating a legal significance of the legal clause, input at least a portion of the document into a machine learning model, the machine learning model outputting a second set of legal clauses responsive to at least the portion of the document input into the machine learning model, determine a set of multiple one-to-one mappings between the first set of legal clauses and the second set of legal clauses based on a vector embedding procedure for the first set of legal clauses and the second set of legal clauses, where a mapping of the set of multiple one-to-one mappings includes a first legal clause from the first set of legal clauses and a second legal clause from the second set of legal clauses, and update the machine learning model based on an evaluation metric corresponding to the set of multiple one-to-one mappings, the evaluation metric based on a longest common substring between the first legal clause and the second legal clause of the mapping.

Another apparatus for machine learning model training for legal clause extraction is described. The apparatus may include means for receiving, from a first user device, a document, means for receiving, from a second user device, an indication of a first set of legal clauses within the document, where a legal clause includes a name and text indicating a legal significance of the legal clause, means for inputting at least a portion of the document into a machine learning model, the machine learning model outputting a second set of legal clauses responsive to at least the portion of the document input into the machine learning model, means for determining a set of multiple one-to-one mappings between the first set of legal clauses and the second set of legal clauses based on a vector embedding procedure for the first set of legal clauses and the second set of legal clauses, where a mapping of the set of multiple one-to-one mappings includes a first legal clause from the first set of legal clauses and a second legal clause from the second set of legal clauses, and means for updating the machine learning model based on an evaluation metric corresponding to the set of multiple one-to-one mappings, the evaluation metric based on a longest common substring between the first legal clause and the second legal clause of the mapping.

A non-transitory computer-readable medium storing code for machine learning model training for legal clause extraction is described. The code may include instructions executable by a processor to receive, from a first user device, a document, receive, from a second user device, an indication of a first set of legal clauses within the document, where a legal clause includes a name and text indicating a legal significance of the legal clause, input at least a portion of the document into a machine learning model, the machine learning model outputting a second set of legal clauses responsive to at least the portion of the document input into the machine learning model, determine a set of multiple one-to-one mappings between the first set of legal clauses and the second set of legal clauses based on a vector embedding procedure for the first set of legal clauses and the second set of legal clauses, where a mapping of the set of multiple one-to-one mappings includes a first legal clause from the first set of legal clauses and a second legal clause from the second set of legal clauses, and update the machine learning model based on an evaluation metric corresponding to the set of multiple one-to-one mappings, the evaluation metric based on a longest common substring between the first legal clause and the second legal clause of the mapping.

Some examples of the method, apparatuses, and non-transitory computer-readable medium described herein may further include operations, features, means, or instructions for transmitting, for display at a third user device, an indication of the evaluation metric, the first set of legal clauses, the second set of legal clauses, a set of multiple longest common substring results for the set of multiple one-to-one mappings, or any combination thereof.

Some examples of the method, apparatuses, and non-transitory computer-readable medium described herein may further include operations, features, means, or instructions for storing a set of multiple legal clauses output by the updated machine learning model.

Some examples of the method, apparatuses, and non-transitory computer-readable medium described herein may further include operations, features, means, or instructions for generating a second document for a tenant of a multi-tenant database system based on one or more legal clauses of the stored set of multiple legal clauses associated with the tenant, storing the second document for the tenant, and generating one or more additional documents, one or more additional legal clauses, or both for the tenant based on the stored second document for the tenant and the one or more legal clauses of the stored plurality of legal clauses associated with the tenant.

Some examples of the method, apparatuses, and non-transitory computer-readable medium described herein may further include operations, features, means, or instructions for transmitting, to a fourth user device associated with a tenant of a multi-tenant database system, a suggested legal clause based on the stored set of multiple legal clauses and a legal jurisdiction associated with the tenant, a geographic location associated with the tenant, a request associated with the tenant, or any combination thereof.

In some examples of the method, apparatuses, and non-transitory computer-readable medium described herein, each legal clause of the set of multiple legal clauses may be stored with an association to a tenant ID of a multi-tenant database system.

Some examples of the method, apparatuses, and non-transitory computer-readable medium described herein may further include operations, features, means, or instructions for determining a set of multiple portions of the document for inputting separately into the machine learning model based on a size of the document and a context window size of the machine learning model.

In some examples of the method, apparatuses, and non-transitory computer-readable medium described herein, determining the set of multiple portions of the document may include operations, features, means, or instructions for determining a start of a first portion of the document, an end of the first portion of the document, or both based on a new line in the document, a full stop in the document, a section header in the document, a white space search of the document, or any combination thereof.

In some examples of the method, apparatuses, and non-transitory computer-readable medium described herein, receiving the indication of the first set of legal clauses within the document may include operations, features, means, or instructions for receiving a JSON array including the first set of legal clauses.

Some examples of the method, apparatuses, and non-transitory computer-readable medium described herein may further include operations, features, means, or instructions for generating a JSON array including the first set of legal clauses based on the indication of the first set of legal clauses within the document.

In some examples of the method, apparatuses, and non-transitory computer-readable medium described herein, updating the machine learning model may include operations, features, means, or instructions for updating a first pair of weight matrices associated with an attention layer of the machine learning model, a second pair of weight matrices associated with a feed forward layer of the machine learning model, or both based on the evaluation metric, where the machine learning model includes one or more attention layers, one or more feed forward layers, or both, multiplying the first pair of weight matrices to determine a first weight matrix and the second pair of weight matrices to determine a second weight matrix, where a first size of the first weight matrix is equal to a second size of a first current weight matrix for the attention layer, and where a third size of the second weight matrix is equal to a fourth size of a second current weight matrix for the feed forward layer, and applying the first weight matrix to the first current weight matrix for the attention layer and the second weight matrix to the second current weight matrix for the feed forward layer to determine the updated machine learning model.

In some examples of the method, apparatuses, and non-transitory computer-readable medium described herein, updating the machine learning model may include operations, features, means, or instructions for iteratively updating the first pair of weight matrices, the second pair of weight matrices, or both based on a set of multiple documents.

Some examples of the method, apparatuses, and non-transitory computer-readable medium described herein may further include operations, features, means, or instructions for refraining from modifying the first current weight matrix for the attention layer and the second current weight matrix for the feed forward layer during the iterative updating.

In some examples of the method, apparatuses, and non-transitory computer-readable medium described herein, determining the set of multiple one-to-one mappings may include operations, features, means, or instructions for determining the set of multiple one-to-one mappings further based on a String match analysis, an edit distance analysis, a unigram overlap analysis, or any combination thereof for the first set of legal clauses and the second set of legal clauses.

In some examples of the method, apparatuses, and non-transitory computer-readable medium described herein, determining the set of multiple one-to-one mappings may include operations, features, means, or instructions for determining a false positive error for the machine learning model based on a third legal clause of the second set of legal clauses failing to map to a fourth legal clause of the first set of legal clauses based on the set of multiple one-to-one mappings, where updating the machine learning model may be further based on the false positive error.

In some examples of the method, apparatuses, and non-transitory computer-readable medium described herein, determining the set of multiple one-to-one mappings may include operations, features, means, or instructions for determining a false negative error for the machine learning model based on a third legal clause of the first set of legal clauses failing to map to a fourth legal clause of the second set of legal clauses based on the set of multiple one-to-one mappings, where updating the machine learning model may be further based on the false negative error.

Some examples of the method, apparatuses, and non-transitory computer-readable medium described herein may further include operations, features, means, or instructions for determining one or more tokens within a word of the document, assigning respective token weights to the one or more tokens based on the word and a corpus of legal language associated with a set of multiple legal clauses, and fine-tuning the machine learning model based on the respective token weights.

Some examples of the method, apparatuses, and non-transitory computer-readable medium described herein may further include operations, features, means, or instructions for determining, from the document, one or more individuals, one or more entities, or both based on an NLP analysis of the document.

The following provides an overview of aspects of the present disclosure:

Aspect 1: A method for machine learning model training for legal clause extraction, comprising: receiving, from a first user device, a document: receiving, from a second user device, an indication of a first set of legal clauses within the document, wherein a legal clause comprises a name and text indicating a legal significance of the legal clause; inputting at least a portion of the document into a machine learning model, the machine learning model outputting a second set of legal clauses responsive to at least the portion of the document input into the machine learning model: determining a plurality of one-to-one mappings between the first set of legal clauses and the second set of legal clauses based at least in part on a vector embedding procedure for the first set of legal clauses and the second set of legal clauses, wherein a mapping of the plurality of one-to-one mappings comprises a first legal clause from the first set of legal clauses and a second legal clause from the second set of legal clauses; and updating the machine learning model based at least in part on an evaluation metric corresponding to the plurality of one-to-one mappings, the evaluation metric based at least in part on a longest common substring between the first legal clause and the second legal clause of the mapping.

Aspect 2: The method of aspect 1, further comprising: transmitting, for display at a third user device, an indication of the evaluation metric, the first set of legal clauses, the second set of legal clauses, a plurality of longest common substring results for the plurality of one-to-one mappings, or any combination thereof.

Aspect 3: The method of any of aspects 1 through 2, further comprising: storing a plurality of legal clauses output by the updated machine learning model.

Aspect 4: The method of aspect 3, further comprising: generating a second document for a tenant of a multi-tenant database system based at least in part on one or more legal clauses of the stored plurality of legal clauses associated with the tenant: storing the second document for the tenant; and generating one or more additional documents, one or more additional legal clauses, or both for the tenant based at least in part on the stored second document for the tenant and the one or more legal clauses of the stored plurality of legal clauses associated with the tenant.

Aspect 5: The method of any of aspects 3 through 4, further comprising: transmitting, to a fourth user device associated with a tenant of a multi-tenant database system, a suggested legal clause based at least in part on the stored plurality of legal clauses and a legal jurisdiction associated with the tenant, a geographic location associated with the tenant, a request associated with the tenant, or any combination thereof.

Aspect 6: The method of any of aspects 3 through 5, wherein each legal clause of the plurality of legal clauses is stored with an association to a tenant ID of a multi-tenant database system.

Aspect 7: The method of any of aspects 1 through 6, further comprising: determining a plurality of portions of the document for inputting separately into the machine learning model based at least in part on a size of the document and a context window size of the machine learning model.

Aspect 8: The method of aspect 7, wherein determining the plurality of portions of the document comprises: determining a start of a first portion of the document, an end of the first portion of the document, or both based at least in part on a new line in the document, a full stop in the document, a section header in the document, a white space search of the document, or any combination thereof.

Aspect 9: The method of any of aspects 1 through 8, wherein receiving the indication of the first set of legal clauses within the document comprises: receiving a JSON array comprising the first set of legal clauses.

Aspect 10: The method of any of aspects 1 through 9, further comprising: generating a JSON array comprising the first set of legal clauses based at least in part on the indication of the first set of legal clauses within the document.

Aspect 11: The method of any of aspects 1 through 10, wherein updating the machine learning model comprises: updating a first pair of weight matrices associated with an attention layer of the machine learning model, a second pair of weight matrices associated with a feed forward layer of the machine learning model, or both based at least in part on the evaluation metric, wherein the machine learning model comprises one or more attention layers, one or more feed forward layers, or both: multiplying the first pair of weight matrices to determine a first weight matrix and the second pair of weight matrices to determine a second weight matrix, wherein a first size of the first weight matrix is equal to a second size of a first current weight matrix for the attention layer, and wherein a third size of the second weight matrix is equal to a fourth size of a second current weight matrix for the feed forward layer; and applying the first weight matrix to the first current weight matrix for the attention layer and the second weight matrix to the second current weight matrix for the feed forward layer to determine the updated machine learning model.

Aspect 12: The method of aspect 11, wherein updating the machine learning model further comprises: iteratively updating the first pair of weight matrices, the second pair of weight matrices, or both based at least in part on a plurality of documents.

Aspect 13: The method of aspect 12, further comprising: refraining from modifying the first current weight matrix for the attention layer and the second current weight matrix for the feed forward layer during the iterative updating.

Aspect 14: The method of any of aspects 1 through 13, wherein determining the plurality of one-to-one mappings comprises: determining the plurality of one-to-one mappings further based at least in part on a String match analysis, an edit distance analysis, a unigram overlap analysis, or any combination thereof for the first set of legal clauses and the second set of legal clauses.

Aspect 15: The method of any of aspects 1 through 14, wherein determining the plurality of one-to-one mappings comprises: determining a false positive error for the machine learning model based at least in part on a third legal clause of the second set of legal clauses failing to map to a fourth legal clause of the first set of legal clauses based at least in part on the plurality of one-to-one mappings, wherein updating the machine learning model is further based at least in part on the false positive error.

Aspect 16: The method of any of aspects 1 through 15, wherein determining the plurality of one-to-one mappings comprises: determining a false negative error for the machine learning model based at least in part on a third legal clause of the first set of legal clauses failing to map to a fourth legal clause of the second set of legal clauses based at least in part on the plurality of one-to-one mappings, wherein updating the machine learning model is further based at least in part on the false negative error.

Aspect 17: The method of any of aspects 1 through 16, further comprising: determining one or more tokens within a word of the document; assigning respective token weights to the one or more tokens based at least in part on the word and a corpus of legal language associated with a plurality of legal clauses; and fine-tuning the machine learning model based at least in part on the respective token weights.

Aspect 18: The method of any of aspects 1 through 17, further comprising: determining, from the document, one or more individuals, one or more entities, or both based at least in part on an NLP analysis of the document.

Aspect 19: An apparatus for machine learning model training for legal clause extraction, comprising one or more memories storing processor-executable code, and one or more processors coupled with the one or more memories and individually or collectively operable to execute the code to cause the apparatus to perform a method of any of aspects 1 through 18.

Aspect 20: An apparatus for machine learning model training for legal clause extraction, comprising at least one means for performing a method of any of aspects 1 through 18.

Aspect 21: A non-transitory computer-readable medium storing code for machine learning model training for legal clause extraction, the code comprising instructions executable by a processor to perform a method of any of aspects 1 through 18.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for machine learning model training for legal entity extraction, comprising:
receiving, from a first user device, a document;
receiving, from a second user device, an indication of a first set of legal clauses within the document, wherein a legal clause comprises a name and text indicating a legal significance of the legal clause;
inputting at least a portion of the document into a machine learning model, the machine learning model outputting a second set of legal clauses responsive to at least the portion of the document input into the machine learning model;
determining a plurality of one-to-one mappings between the first set of legal clauses and the second set of legal clauses based at least in part on a vector embedding procedure for the first set of legal clauses and the second set of legal clauses, wherein a mapping of the plurality of one-to-one mappings comprises a first legal clause from the first set of legal clauses and a second legal clause from the second set of legal clauses; and
updating the machine learning model based at least in part on an evaluation metric corresponding to the plurality of one-to-one mappings, the evaluation metric based at least in part on a longest common substring between the first legal clause and the second legal clause of the mapping.

2. The method of claim 1, further comprising:
transmitting, for display at a third user device, an indication of the evaluation metric, the first set of legal clauses, the second set of legal clauses, a plurality of longest common substring results for the plurality of one-to-one mappings, or any combination thereof.

3. The method of claim 1, further comprising:
storing a plurality of legal clauses output by the updated machine learning model.

4. The method of claim 3, further comprising:
generating a second document for a tenant of a multi-tenant database system based at least in part on one or more legal clauses of the stored plurality of legal clauses associated with the tenant;
storing the second document for the tenant; and
generating one or more additional documents, one or more additional legal clauses, or both for the tenant based at least in part on the stored second document for the tenant and the one or more legal clauses of the stored plurality of legal clauses associated with the tenant.

5. The method of claim 3, further comprising:
transmitting, to a fourth user device associated with a tenant of a multi-tenant database system, a suggested legal clause based at least in part on the stored plurality of legal clauses and a legal jurisdiction associated with the tenant, a geographic location associated with the tenant, a request associated with the tenant, or any combination thereof.

6. The method of claim 3, wherein each legal clause of the plurality of legal clauses is stored with an association to a tenant identifier of a multi-tenant database system.

7. The method of claim 1, further comprising:
determining a plurality of portions of the document for inputting separately into the machine learning model based at least in part on a size of the document and a context window size of the machine learning model.

8. The method of claim 7, wherein determining the plurality of portions of the document comprises:
determining a start of a first portion of the document, an end of the first portion of the document, or both based at least in part on a new line in the document, a full stop in the document, a section header in the document, a white space search of the document, or any combination thereof.

9. The method of claim 1, wherein receiving the indication of the first set of legal clauses within the document comprises:
receiving a JavaScript Object Notation (JSON) array comprising the first set of legal clauses.

10. The method of claim 1, further comprising:
generating a JavaScript Object Notation (JSON) array comprising the first set of legal clauses based at least in part on the indication of the first set of legal clauses within the document.

11. The method of claim 1, wherein updating the machine learning model comprises:
updating a first pair of weight matrices associated with an attention layer of the machine learning model, a second pair of weight matrices associated with a feed forward layer of the machine learning model, or both based at least in part on the evaluation metric, wherein the machine learning model comprises one or more attention layers, one or more feed forward layers, or both;
multiplying the first pair of weight matrices to determine a first weight matrix and the second pair of weight matrices to determine a second weight matrix, wherein a first size of the first weight matrix is equal to a second size of a first current weight matrix for the attention layer, and wherein a third size of the second weight matrix is equal to a fourth size of a second current weight matrix for the feed forward layer; and
applying the first weight matrix to the first current weight matrix for the attention layer and the second weight matrix to the second current weight matrix for the feed forward layer to determine the updated machine learning model.

12. The method of claim 11, wherein updating the machine learning model further comprises:
iteratively updating the first pair of weight matrices, the second pair of weight matrices, or both based at least in part on a plurality of documents.

13. The method of claim 12, further comprising:
refraining from modifying the first current weight matrix for the attention layer and the second current weight matrix for the feed forward layer during the iterative updating.

14. The method of claim 1, wherein determining the plurality of one-to-one mappings comprises:
determining the plurality of one-to-one mappings further based at least in part on a String match analysis, an edit distance analysis, a unigram overlap analysis, or any combination thereof for the first set of legal clauses and the second set of legal clauses.

15. The method of claim 1, wherein determining the plurality of one-to-one mappings comprises:
determining a false positive error for the machine learning model based at least in part on a third legal clause of the second set of legal clauses failing to map to a fourth legal clause of the first set of legal clauses based at least in part on the plurality of one-to-one mappings, wherein updating the machine learning model is further based at least in part on the false positive error.

16. The method of claim 1, wherein determining the plurality of one-to-one mappings comprises:
determining a false negative error for the machine learning model based at least in part on a third legal clause of the first set of legal clauses failing to map to a fourth legal clause of the second set of legal clauses based at least in part on the plurality of one-to-one mappings, wherein updating the machine learning model is further based at least in part on the false negative error.

17. The method of claim 1, further comprising:
determining one or more tokens within a word of the document;
assigning respective token weights to the one or more tokens based at least in part on the word and a corpus of legal language associated with a plurality of legal clauses; and
fine-tuning the machine learning model based at least in part on the respective token weights.

18. The method of claim 1, further comprising:
determining, from the document, one or more individuals, one or more entities, or both based at least in part on a natural language processing analysis of the document.

19. An apparatus for machine learning model training for legal entity extraction, comprising:
one or more memories storing processor-executable code; and
one or more processors coupled with the one or more memories and individually or collectively operable to execute the code to cause the apparatus to:
receive, from a first user device, a document;
receive, from a second user device, an indication of a first set of legal clauses within the document, wherein a legal clause comprises a name and text indicating a legal significance of the legal clause;
input at least a portion of the document into a machine learning model, the machine learning model outputting a second set of legal clauses responsive to at least the portion of the document input into the machine learning model;
determine a plurality of one-to-one mappings between the first set of legal clauses and the second set of legal clauses based at least in part on a vector embedding procedure for the first set of legal clauses and the second set of legal clauses, wherein a mapping of the plurality of one-to-one mappings comprises a first legal clause from the first set of legal clauses and a second legal clause from the second set of legal clauses; and
update the machine learning model based at least in part on an evaluation metric corresponding to the plurality of one-to-one mappings, the evaluation metric based at least in part on a longest common substring between the first legal clause and the second legal clause of the mapping.

20. A non-transitory computer-readable medium storing code for machine learning model training for legal entity extraction, the code comprising instructions executable by one or more processors to:
receive, from a first user device, a document;
receive, from a second user device, an indication of a first set of legal clauses within the document, wherein a legal clause comprises a name and text indicating a legal significance of the legal clause;
input at least a portion of the document into a machine learning model, the machine learning model outputting a second set of legal clauses responsive to at least the portion of the document input into the machine learning model;
determine a plurality of one-to-one mappings between the first set of legal clauses and the second set of legal clauses based at least in part on a vector embedding procedure for the first set of legal clauses and the second set of legal clauses, wherein a mapping of the plurality of one-to-one mappings comprises a first legal clause from the first set of legal clauses and a second legal clause from the second set of legal clauses; and
update the machine learning model based at least in part on an evaluation metric corresponding to the plurality of one-to-one mappings, the evaluation metric based at least in part on a longest common substring between the first legal clause and the second legal clause of the mapping.
